(19) United States
(12) Patent Application Publication
(10) Pub. No.: US 2026/0220536 A1
(43) Pub. Date: Jul. 30, 2026

(54) INFORMATION PROCESSING DEVICE AND METHOD, AND PROGRAM

(71) Applicant: SONY GROUP CORPORATION, TOKYO (JP)

(72) Inventors: SOTA SHOMAN, TOKYO (JP); KENJI GOTOH, TOKYO (JP); JUNJI OTSUKA, TOKYO (JP); YUGO SATO, TOKYO (JP)

(21) Appl. No.: 19/147,733

(22) PCT Filed: Jan. 11, 2024
(86) PCT No.: PCT/JP2024/000345

§ 371 Date: Jul. 14, 2025

(30) Foreign Application Priority Data
Jan. 24, 2023 (JP) 2023-008464

(51) Int. Cl. G06N 20/00

(52) U.S. Cl. CPC G06N 20/00

(57) ABSTRACT

The present technology relates to an information processing device, a method, and a program that enables easier selection of an appropriate model. The information processing device includes: an inference unit that generates a plurality of pieces of second data by applying weak perturbations to first data without annotation obtained in an unknown environment, and performs, using the pieces of second data as inputs to a model, inference on the pieces of second data based on the model; a deviation calculation unit that calculates, based on a result of the inference on the plurality of pieces of second data, a deviation of the result of the inference; and a model selection unit that selects, based on the deviation for each of a plurality of the models, one or more of the models from among the plurality of models. The present technology can be applied to an information processing device.

### TECHNICAL FIELD

The present technology relates to an information processing device and method, and a program, and more particularly to an information processing device and method, and a program that enables easier selection of an appropriate model.

### BACKGROUND ART

There are cases where given a plurality of machine learning models that perform a given inference, it is desired to select an appropriate machine learning model from among the machine learning models, for evaluation data without annotation obtained in an unknown environment. As a specific example, there is a possible case in which an appropriate machine learning model is selected as, for example, a machine learning model for a specific application to be installed on a smartphone.

As a technology related to machine learning, a technology has been proposed in which a classifier makes inferences on unlabeled data, and if the inference results are reliable, the data is used as labeled data to re-train the classifier (e.g., see PTL 1).

### CITATION LIST

### Patent Literature

### [PTL 1]

JP 2022-120588A. SUMMARY

### Technical Problem

However, with the above-described technology, it is not easy to select an appropriate model from among a plurality of machine learning model models.

Typically, annotation is required to evaluate a machine learning model, and each time evaluation in a new environment is required, evaluation data is required to be obtained by, for example, image capturing, and then annotated, making the selection of a machine learning model time-consuming.

In addition, while the technology described in PTL 1 can improve the inference accuracy of a classifier, it cannot select an appropriate model from among a plurality of machine learning models.

The present technology has been made in view of such circumstances, and enables easier selection of an appropriate model.

### Solution to Problem

An information processing device according to a first aspect of the present technology includes: an inference unit that generates a plurality of pieces of second data by applying weak perturbations to first data without annotation obtained in an unknown environment, and performs, using the pieces of second data as inputs to a model, inference on the pieces of second data based on the model; a deviation calculation unit that calculates, based on a result of the inference on the plurality of pieces of second data, a deviation of the result of the inference; and a model selection unit that selects, based on the deviation for each of a plurality of the models, one or more of the models from among the plurality of models.

An information processing method or a program according to a first aspect of the present technology includes the steps of: generating a plurality of pieces of second data by applying weak perturbations to first data without annotation obtained in an unknown environment; performing, using the pieces of second data as inputs to a model, inference on the pieces of second data based on the model; calculating, based on a result of the inference on the plurality of pieces of second data, a deviation of the result of the inference; and selecting, based on the deviation for each of a plurality of the models, one or more of the models from among the plurality of models.

In the first aspect of the present technology, a plurality of pieces of second data is generated by applying weak perturbations to first data without annotation obtained in an unknown environment; using the pieces of second data as inputs to a model, inference on the pieces of second data based on the model is performed; based on a result of the inference on the plurality of pieces of second data, a deviation of the result of the inference is calculated; and based on the deviation for each of a plurality of the models, one or more of the models are selected from among the plurality of models.

### BRIEF DESCRIPTION OF DRAWINGS

FIG. 1 is a diagram illustrating a configuration example of a model sorting device.

FIG. 2 is a diagram illustrating a configuration example of an inference device.

FIG. 3 is a flowchart illustrating model selection processing.

FIG. 4 is a flowchart illustrating inference processing.

FIG. 5 illustrates perturbations applied to a hand region.

FIG. 6 illustrates an example of detection results of hand keypoint positions.

FIG. 7 is a diagram illustrating evaluation of combinations of evaluation data and hand keypoint detection models.

FIG. 8 is a flowchart illustrating detection deviation calculation processing.

FIG. 9 is a flowchart illustrating correct/incorrect determination processing based on a user's determination.

FIG. 10 illustrates a display screen example.

FIG. 11 illustrates learning data for a correct/incorrect determination model.

FIG. 12 is a flowchart illustrating C-determination processing.

FIG. 13 illustrates a display screen example.

FIG. 14 is a flowchart illustrating correct/incorrect determination processing using a correct/incorrect determination model.

FIG. 15 is a flowchart illustrating learning data addition processing.

FIG. 16 is a flowchart illustrating sorting processing.

FIG. 17 is a flowchart illustrating model presentation processing.

FIG. 18 is a diagram illustrating a configuration example of a computer.

### DESCRIPTION OF EMBODIMENTS

Embodiments to which the present technology is applied will be described below with reference to the accompanying drawings.

### First Embodiment

### <Configuration Example of Model Sorting Device>

This technology enables easier selection of an appropriate machine learning model from among a plurality of machine learning models that perform a given inference, by evaluating a deviation of an inference result when weak perturbations are applied to inputs, for evaluation data without annotation obtained in an unknown environment.

In particular, the present technology makes it possible to select a highly stable machine learning model from among a plurality of machine learning models for evaluation data, and further makes it possible to improve the machine learning model with a user's assistance and the like by presenting, to the user, evaluation data that is poorly suited for machine learning models.

The present technology may use any machine learning model, but an example of inference using a machine learning model will be described below in which keypoint detection is performed to detect the positions of keypoints in an image.

In general, data augmentation is often performed for learning of a machine learning model. The inventor(s) applied data augmentation and hypothesized that the keypoint detection positions in images obtained when weak perturbations were applied to images (evaluation data) that are inputs to the machine learning model would be the same. In addition, experiments revealed that there is a high correlation between the maximum deviation of keypoint detection positions and the stability of the machine learning model.

By applying the results of the experiments, the present technology makes it possible to systematize the sorting (selection) of an appropriate machine learning model, the identification of evaluation data that is poorly suited for machine learning models, and the improvement of machine learning models.

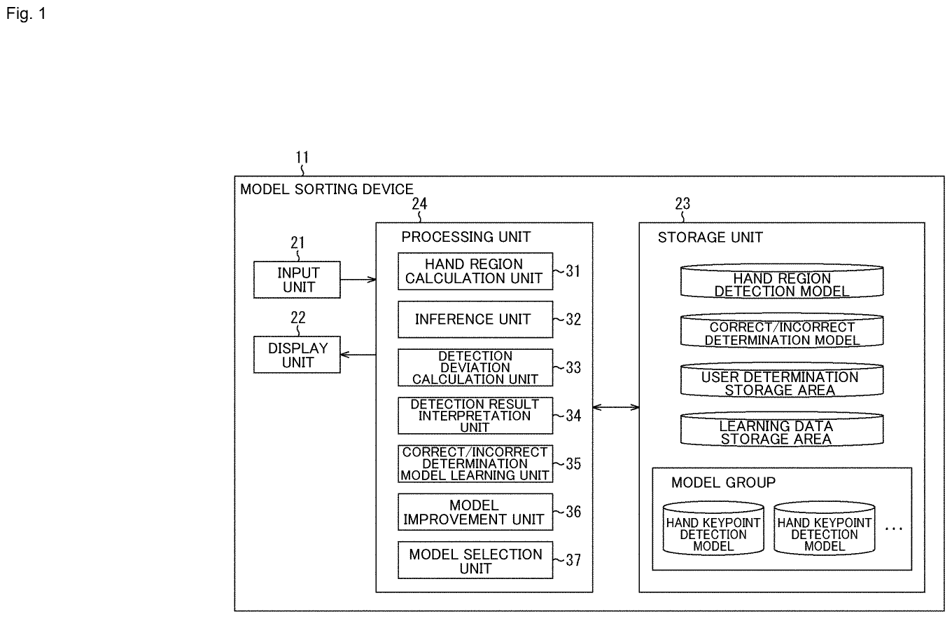

FIG. 1 is a diagram illustrating a configuration example of an embodiment of a model sorting device to which the present technology is applied.

The model sorting device 11 illustrated in FIG. 1 is made up of an information processing device such as a personal computer to be used by, for example, engineers engaged in product development, research, development, and the like.

The model sorting device 11 stores in advance, as a machine learning model, a hand keypoint detection model that detects the positions of hand keypoints (hereinafter also referred to as hand keypoints) from an input image (image data).

The hand keypoint detection model is a learned machine learning model that detects on the basis of an input image the positions of a plurality of keypoints of a hand, which is a subject appearing in the input image, thereby detecting (infers) the posture of the hand. A hand keypoint is a specific part of the hand, such as a joint, that is important for inferring the posture of the hand, and the parts to be detected as hand keypoints are defined in advance.

The model sorting device 11 selects (sorts) from among a plurality of hand keypoint detection models a model that is suitable for use in a new, unknown environment, that is, a model that is suitable for installation in an inference device such as a smartphone that will be used in a new, unknown environment or the like.

In selecting a hand keypoint detection model, data without annotation obtained in a new, unknown environment for the hand keypoint detection model is used as evaluation data. More specifically, one or more images (image data) captured in a new, unknown environment without annotations are used as evaluation data.

The model sorting device 11 includes an input unit 21, a display unit 22, a storage unit 23, and a processing unit 24.

The input unit 21 includes a mouse, a keyboard, various sensors such as an image sensor, and the like. Examples of the sensors making up the input unit 21 include an image sensor that captures a color image such as RGB or a grayscale image (monochrome image), and a distance measurement sensor that measures the distance (depth) to a subject, that is, captures a depth image.

For example, a mouse or a keyboard serving as the input unit 21 supplies a signal to the processing unit 24 in response to a user operation.

For example, a sensor serving as the input unit 21 captures an image of a surrounding subject and supplies the resulting image, that is, evaluation data, to the processing unit 24. An evaluation data storage area of the storage unit 23 in which the evaluation data is stored may function as the input unit 21, and the evaluation data read out from the evaluation data storage area may be supplied to the processing unit 24.

The display unit 22 is made up of a display, and displays various types of images supplied from the processing unit 24. For example, the display unit 22 displays a display screen for selection (sorting) of a hand keypoint detection model and for learning of the model, and the like.

The storage unit 23 is made up of, for example, a non-volatile memory, and stores data supplied from the processing unit 24 and supplies the stored data to the processing unit 24.

The storage unit 23 stores, for example, a hand region detection model, a correct/incorrect determination model, a hand keypoint detection model, and the like. In particular, in the storage unit 23, a plurality of hand keypoint detection models obtained in advance by learning are stored as a model group.

The hand region detection model is a machine learning model that uses image data (images) such as evaluation data as inputs, detects a hand region in an input image, and outputs the detection result.

The correct/incorrect determination model is a machine learning model that uses an image and the positions of hand keypoints detected from that image as inputs, and outputs a result of correct/incorrect determination as to whether the detection result of the input positions of hand keypoints is reliable or not, that is, whether the detection result is correct or incorrect. In other words, the correct/incorrect determination model is a model that determines whether the detection result of hand keypoints from an image is correct or incorrect.

The hand region detection model, the correct/incorrect determination model, and the hand keypoint detection model may be stored in an external device different from the model sorting device 11, and the hand region detection model, the correct/incorrect determination model, and the hand keypoint detection model may be acquired (read out) from the external device.

For example, the storage unit 23 also has a user determination storage area in which learning data for learning of a correct/incorrect determination model is stored on the basis of a user's determination, and a learning data storage area in which learning data for learning of a hand keypoint detection model is stored. Thus, the storage unit 23 also stores learning data for the correct/incorrect determination model and learning data for the hand keypoint detection model.

In addition, as described above, the storage unit 23 may have an evaluation data storage area so that evaluation data can be stored in the evaluation data storage area.

The processing unit 24 controls the overall operations of the model sorting device 11. The processing unit 24 includes a hand region calculation unit 31, an inference unit 32, a detection deviation calculation unit 33, a detection result interpretation unit 34, a correct/incorrect determination model learning unit 35, a model improvement unit 36, and a model selection unit 37.

The hand region calculation unit 31 detects a hand region from evaluation data based on the hand region detection model stored in the storage unit 23. The technique for detecting a hand region is not limited to the technique using the hand region detection model, and any other technique may be used.

On the basis of the hand keypoint detection model stored in the storage unit 23, the inference unit 32 detects (infers) the positions of hand keypoints associated with evaluation data, in other words, detects the posture of a hand. More specifically, the inference unit 32 generates a plurality of cropped images (image data of the cropped images) by applying weak perturbations to the hand region of the evaluation data, performs inference for each of the cropped images based on the hand keypoint detection model, and detects the positions of hand keypoints in each cropped image.

On the basis of the detection result of the positions of hand keypoints from each of the plurality of cropped images, that is, the inference result for each of the plurality of cropped images, the detection deviation calculation unit 33 calculates the deviation of detection results (inference results) of the positions of hand keypoints (hereinafter referred to as the detection deviation).

The detection deviation is an index for evaluating the stability when detecting hand keypoints (the posture of the hand) from evaluation data using a hand keypoint detection model, and is calculated (computed) for each hand keypoint detection model for one or more pieces of evaluation data.

The detection result interpretation unit 34 interprets the result of detection deviation calculation for each combination of evaluation data and hand keypoint detection model based on the detection result (inference result) of hand keypoint positions and the detection deviation. In other words, the detection result interpretation unit 34 evaluates the reliability and stability of the detection (inference) of the hand keypoints for the combination of evaluation data and hand keypoint detection model.

Depending on the interpretation result (evaluation result) of the result of detection deviation calculation, the detection results of hand keypoint positions and the like are stored in the learning data storage area and the user determination storage area as learning data for the hand keypoint detection model and the correct/incorrect determination model.

The correct/incorrect determination model learning unit 35 performs learning of the correct/incorrect determination model based on the learning data stored in the user determination storage area.

The model improvement unit 36 improves the hand keypoint detection model based on the learning data stored in the learning data storage area. Specifically, the model improvement unit 36 performs learning based on the learning data to generate a new hand keypoint detection model.

The model selection unit 37 selects one or more appropriate hand keypoint detection models from among a plurality of hand keypoint detection models including hand keypoint detection models stored in advance (prepared in advance) and the new learned hand keypoint detection model. At this time, the model selection unit 37 selects the hand keypoint detection model based on the detection deviation, more specifically, by using an index based on the detection deviation.

### <Configuration Example of Inference Device>

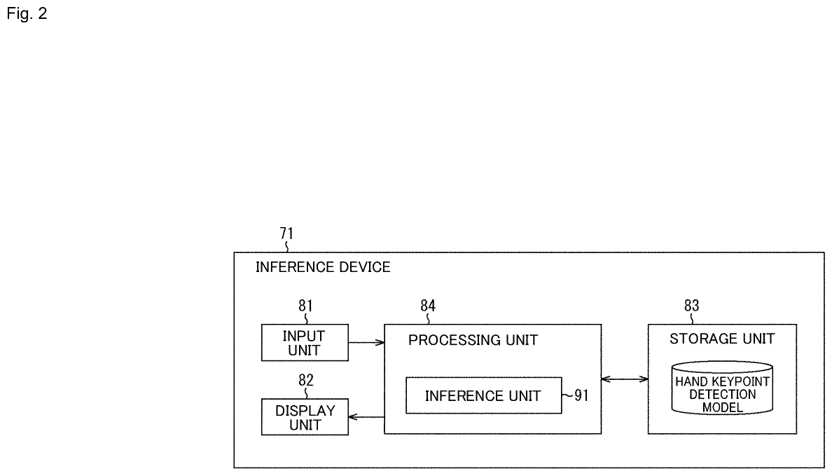

An inference device in which the hand keypoint detection model(s) selected by the model sorting device 11 are installed and which detects hand keypoints based on the hand keypoint detection model is configured, for example, as illustrated in FIG. 2.

The inference device 71 illustrated in FIG. 2 is made up of an information processing device such as a smartphone used by, for example, an end user, and implements a hand recognition function by the hand keypoint detection model installed therein. In the inference device 71, such a hand recognition function is utilized in certain applications.

The inference device 71 includes an input unit 81, a display unit 82, a storage unit 83, and a processing unit 84.

The input unit 81 includes, for example, a touch panel, buttons, and various sensors such as an image sensor and a distance measurement sensor.

For example, a touch panel or a button serving as the input unit 81 supplies a signal to the processing unit 84 in response to a user operation. For example, a sensor serving as the input unit 81 captures an image of a surrounding subject and supplies the resulting image (image data) to the processing unit 84.

The display unit 82 is made up of a display and displays various types of images supplied from the processing unit 84. For example, the display unit 82 displays a display screen of an application that uses a hand keypoint detection model.

The storage unit 83 is made up of, for example, a non-volatile memory, and stores data supplied from the processing unit 84 and supplies the stored data to the processing unit 84. For example, the storage unit 83 stores the hand keypoint detection model(s) selected by the model sorting device 11.

The processing unit 84 controls the overall operations of the inference device 71. The processing unit 84 includes an inference unit 91.

On the basis of the hand keypoint detection model(s) stored in the storage unit 83, the inference unit 91 detects (infers) the positions of hand keypoints from an image input from the input unit 81, that is, the posture of a hand in the image.

### <Description of Model Selection Processing>

Next, operations of the model sorting device 11 and the inference device 71 will be described.

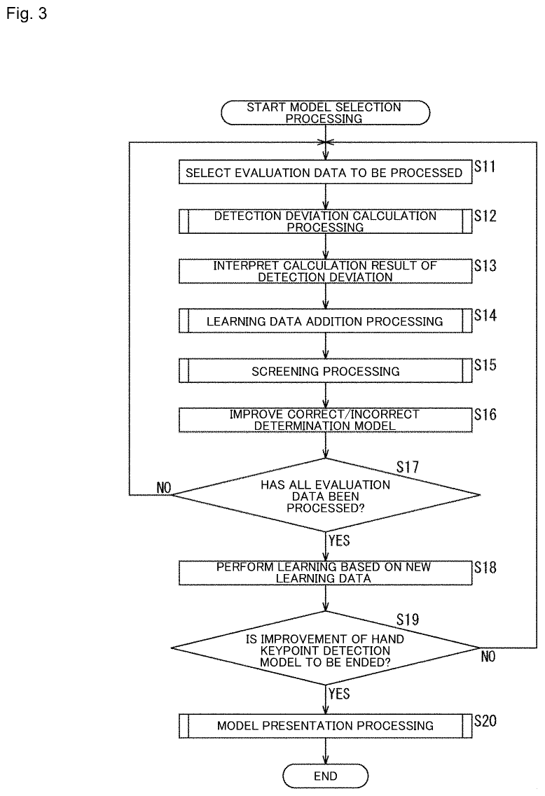

First, the operation of the model sorting device 11 will be described. Model selection processing performed by the model sorting device 11 will be described below with reference to a flowchart of FIG. 3.

For example, the model selection processing is started when one or more pieces of evaluation data are supplied (input) from the input unit 21 to the processing unit 24.

The evaluation data is image data without annotation obtained by image capturing in an unknown environment. The unknown environment as referred to herein is an environment different from the environment in which data has been acquired during learning of the hand keypoint detection model(s) stored in advance in the storage unit 23, and is, for example, the environment in which the inference device 71 is used.

In step S11, the processing unit 24 selects one piece of evaluation data to be processed from the pieces of evaluation data supplied from the input unit 21. Once the evaluation data to be processed is selected, processing of steps S12 to S16 are then performed on the selected evaluation data.

In step S12, the processing unit 24 performs detection deviation calculation processing based on the evaluation data to be processed.

In the detection deviation calculation processing, for each hand keypoint detection model stored in the storage unit 23, when weak perturbations are applied to the evaluation data and the positions of hand keypoints are detected, a deviation of the detection results (detection positions) is calculated as a detection deviation. Details of the detection deviation calculation processing will be described later.

In step S13, the detection result interpretation unit 34 interprets the calculation result of the detection deviation based on the detection deviation calculated for each hand keypoint detection model in the processing of step S12 for the evaluation data to be processed and based on the detection results of the hand keypoint positions.

In step S13, the reliability and stability of detection is evaluated when detecting the positions of hand keypoints from the evaluation data using the hand keypoint detection models, based on the detection deviation.

Details will be described later, but for example, in step S13, it is determined (interpreted) which of three groups related to evaluation results a combination of evaluation data and a hand keypoint detection model belongs to, that is, which of three evaluations it belongs to.

Also in step S13, cropped images and the like used in the calculation of the detection deviation are stored as appropriate in the user determination storage area of the storage unit 23 as learning data for the correct/incorrect determination model.

When the processing of step S13 has been performed, then the processing of steps S14 to S16 is performed in parallel.

In step S14, the model improvement unit 36 performs learning data addition processing based on the determination result (interpretation result) of evaluation of each of the combinations of evaluation data and hand keypoint detection models, obtained in the processing of step S13.

Details of the learning data addition processing will be described later, but in the learning data addition processing, evaluation data and the like of scenes that are determined to be poorly suited for the hand keypoint detection model based on the determination result of evaluation are added to the learning data storage area of the storage unit 23 as learning data for the hand keypoint detection model.

In step S15, the model improvement unit 36 performs screening processing based on the determination result (interpretation result) of evaluation of each of the combinations of evaluation data and hand keypoint detection models, obtained in the processing of step S13.

In the screening processing, processing is performed as appropriate such as prompting the user to recheck the learning data for the hand keypoint detection model, and adding appropriate evaluation data and the like as learning data to the learning data storage area. Details of the screening processing will be described later.

In step S16, the correct/incorrect determination model learning unit 35 improves the correct/incorrect determination model. Specifically, the correct/incorrect determination model learning unit 35 performs learning based on the learning data stored in the user determination storage area of the storage unit 23, to generate a correct/incorrect determination model. The correct/incorrect determination model learning unit 35 also supplies the correct/incorrect determination model obtained by learning to the storage unit 23 for storage therein.

At this time, if a correct/incorrect determination model is already stored in the storage unit 23, that correct/incorrect determination model may be used for learning to generate a new correct/incorrect determination model, or a new correct/incorrect determination model may be generated without using the existing correct/incorrect determination model for learning.

The learning of the correct/incorrect determination model, that is, the processing of step S16, is performed only when an instruction to perform learning is given by the user. Therefore, when there is no instruction to perform learning from the user, the processing of step S16 is not performed.

In step S17, the processing unit 24 determines whether or not all the pieces of evaluation data supplied from the input unit 21 has been processed, that is, whether or not the processing of steps S12 to S16 has been performed for all the pieces of evaluation data to be processed.

If it is determined in step S17 that the processing has not yet been performed for all the pieces of evaluation data, then the processing returns to step S11 to repeat the above-described processing.

On the other hand, if it is determined in step S17 that all the pieces of evaluation data have been processed, then the processing proceeds to step S18.

In step S18, the model improvement unit 36 performs learning (machine learning) based on the new learning data stored in the learning data storage area of the storage unit 23, to generate a new hand keypoint detection model. Thus, a new hand keypoint detection model that has been improved over the hand keypoint detection model already stored in the storage unit 23 is learned.

The model improvement unit 36 supplies the new hand keypoint detection model obtained by learning to the storage unit 23 for storage therein. Specifically, the newly generated hand keypoint detection model is added to the model group stored in the storage unit 23.

The hand keypoint detection model added to the model group in step S18 is likely to be more suitable for use in the environment in which the evaluation data was captured than the existing hand keypoint detection models stored before the model selection processing is started.

When the user determines that a hand keypoint detection model has been obtained that is accurate and stable enough for use in an unknown environment, that is, the environment in which the evaluation data was captured, the user operates the input unit 21 to instruct the end of improving the hand keypoint detection model.

In step S19, the processing unit 24 determines, based on a signal in response to a user operation supplied from the input unit 21, whether or not to end the improvement of the hand keypoint detection model, that is, whether or not to end the generation of a new hand keypoint detection model by learning.

If it is determined in step S19 that the improvement of the hand keypoint detection model is not to be ended, the processing returns to step S11 to repeat the above-described processing. Thus, a further improved hand keypoint detection model is added to the model group. In this case, new evaluation data may be added as necessary.

On the other hand, if it is determined in step S19 that the improvement of the hand keypoint detection model is to be ended, then the processing proceeds to step S20.

In step S20, the processing unit 24 performs model presentation processing.

Details of the model presentation processing will be described later, but in the model presentation processing, several hand keypoint detection models suitable for the environment in which the inference device 71 is used, that is, the environment in which the evaluation data was captured, are selected from among the plurality of hand keypoint detection models stored in the storage unit 23.

Here, a detection deviation is calculated for each hand keypoint detection model based on evaluation data, and an appropriate hand keypoint detection model is selected on the basis of an index based on the resulting detection deviation. The number of hand keypoint detection models selected in the model presentation processing may be one, or two or more (plural).

When some (one or more) appropriate hand keypoint detection models are selected, the selection result is displayed on the display unit 22. In other words, the result of selecting hand keypoint detection models is presented to the user.

For example, the user refers to the selection result displayed (presented) on the display unit 22 and selects a hand keypoint detection model to be installed in the inference device 71.

In this case, the user may select from among one or more hand keypoint detection models presented by the model sorting device 11 a hand keypoint detection model to be finally installed in the inference device 71. Therefore, the user can more easily select an appropriate hand keypoint detection model.

When the model presentation processing has been performed, the model selection processing ends.

As described above, the model sorting device 11 uses the detection deviation when weak perturbations are applied to the evaluation data as an index to improve the hand keypoint detection model or to select an appropriate hand keypoint detection model from among the model group. In this way, the detection deviation being used as an index enables easier selection of an appropriate hand keypoint detection model.

### <Description of Inference Processing>

In the inference device 71 in which the hand keypoint detection model selected by the model sorting device 11 is installed, when an application using the hand keypoint detection model is executed, the hand keypoint detection model is used as appropriate to perform hand recognition.

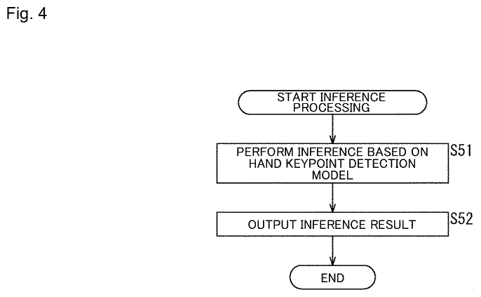

In such a case, the inference device 71 performs, for example, processing illustrated in FIG. 4. Inference processing performed by the inference device 71 will be described below with reference to a flowchart in FIG. 4. This inference processing is started when an image (image data) as a target for hand recognition, that is, as a target for hand posture detection, is supplied from the input unit 81 to the processing unit 84.

In step S51, the inference unit 91 of the processing unit 84 performs inference on the image supplied from the input unit 81 based on the hand keypoint detection model stored in the storage unit 83.

Specifically, the inference unit 91 inputting the image supplied from the input unit 81 into the hand keypoint detection model and performing calculations (computations) to detect (infer) the positions of a plurality of hand keypoints in the image. Thus, a detection result (inference result) of hand posture including the positions of the hand keypoints is obtained.

In step S52, the processing unit 84 outputs the inference result obtained in step S51 to a block that uses the inference result, and then the inference processing ends.

For example, the processing unit 84 outputs (supplies) the detection result of hand posture to a processing block that implements an application that performs processing according to the detection result of hand posture by the inference unit 91.

As described above, the inference device 71 detects the positions of the hand keypoints, that is, the hand posture, using the installed hand keypoint detection model.

In particular, the inference device 71 detects the hand posture using the hand keypoint detection model selected in the model sorting device 11. Therefore, the inference device 71 can detect the hand posture more stably and with higher accuracy by using the hand keypoint detection model appropriate for the environment in which the inference device 71 is used.

### <Detection Deviation and Interpretation of Result of Detection Deviation Calculation>

Next, the processing performed in each step of the model selection processing described with reference to FIG. 3 will be described in more detail.

In the detection deviation calculation processing of step S12, weak perturbations are added to the evaluation data to generate a plurality of cropped images, and each of these cropped images is used as an input to a hand keypoint detection model to perform inference, thereby calculating a detection deviation for each hand keypoint detection model.

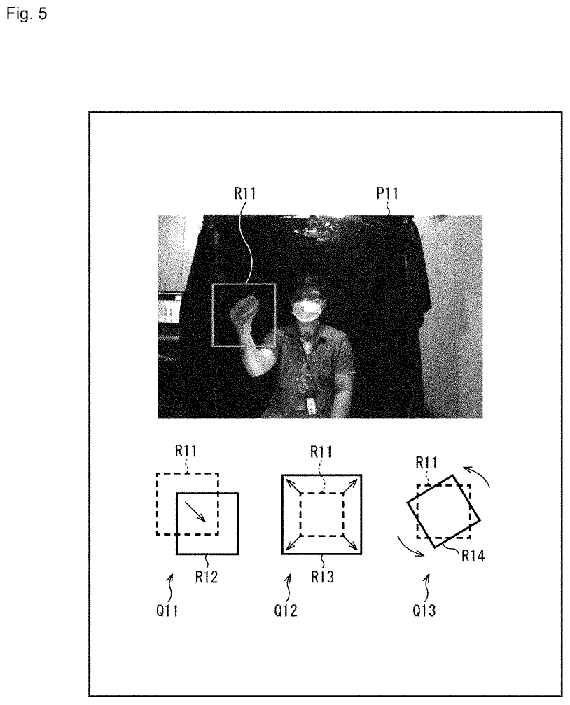

Specifically, for example, it is assumed that an image P11 illustrated in FIG. 5 is input as evaluation data.

In this example, the image P11 serving as evaluation data includes a person and the person's hand serving as a subject.

In this case, a hand region R11, which is a region (hand region) in which the hand appears as the subject, is detected from the image P11 by the hand region calculation unit 31. Although hand keypoints represented by circles are depicted in the hand portion in the image P11 in this example, the image serving as evaluation data does not actually include circles (images) representing the hand keypoints.

The inference unit 32 applies a weak perturbation to the hand region R11 in the image P11, and cuts out the hand region portion of the image P11 after the perturbation is applied, thereby generating a cropped image.

In this case, as the weak perturbation, for example, a perturbation as indicated by arrows Q11 to Q13 is applied (added).

In the example indicated by the arrow Q11, a short distance shift is applied as a perturbation to the hand region R11, and the portion of a hand region R12 after the shift is cut out to generate one cropped image.

In the example indicated by the arrow Q12, enlargement with low magnification, that is, scaling (scale transformation), is applied as a perturbation to the hand region R11, and the portion of a hand region R13 after the scaling is cut out to generate one cropped image. The scaling is not limited to enlargement, and reduction may be made.

In the example indicated by the arrow Q13, a small angle of rotation is applied as a perturbation to the hand region R11, and the portion of a hand region R14 after the rotation is cut out to generate one cropped image.

The weak perturbation applied to a hand region is not limited to the above-mentioned shift, scaling, and rotation, and may be any other type.

For example, weak perturbations to be added may include processing of making a color change to the entire image P11 (the entire hand region R11) (color change), replacing part of the background in the image P11 (hand region R11) with another image, and filling part or all of the background and the like with a specific color or pattern.

In the inference unit 32, a plurality of different types of weak perturbations are applied to the hand region of the evaluation data, and a plurality of S cropped images are generated from one piece of evaluation data. As a specific example, 20 cropped images are generated from one piece of evaluation data.

The inference unit 32 performs calculations (computations) using each cropped image thus generated as an input to a hand keypoint detection model, and detects the positions of hand keypoints in the cropped image. Thus, the inference unit 32 performs inference on the cropped image based on the hand keypoint detection model.

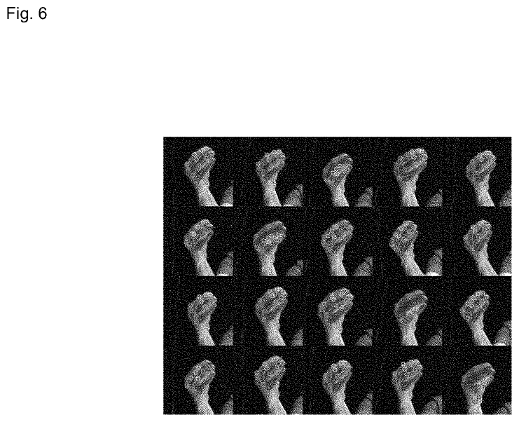

For example, when 20 cropped images are generated, results illustrated in FIG. 6 are obtained as the detection results of the positions of the hand keypoints from the cropped images.

In an example illustrated in FIG. 6, a total of 20 cropped images are arranged, four vertically and five horizontally, and the circles on the cropped images represent the positions of the detected hand keypoints. Data including the detection result of the positions of all the hand keypoints in a cropped image is the detection result of hand posture.

As described above, each cropped image has a different weak perturbation added to the hand region of the evaluation data.

Among the 20 cropped images, for the applied perturbations, there are some images in which the positions of the hand keypoints are correctly detected, and some images in which the positions of the hand keypoints are incorrect.

The detection deviation calculation unit 33 calculates a detection deviation δ for each combination of evaluation data and hand keypoint detection model based on the detection results of the positions of the hand keypoints from the cropped images, that is, the detection results of the hand posture.

Specifically, for example, the detection deviation calculation unit 33 calculates the detection deviation δ by calculating the following Equation (1).

$$\begin{matrix}[ Math . 1 ] & \\ δ = {max}_{sjd} \vert {p}_{sjd} - {median}_{s} ( {p}_{sjd} ) \vert & ( 1 )\end{matrix}$$

In Equation (1), s, j, and d denote the indexes of cropped images, hand keypoints, and dimensions, respectively.

For example, the total number of cropped images (number of samples) indicated by index s is set to 20, the total number of hand keypoints (number of joints) indicated by index j is set to 21, and the number of dimensions (number of dimensions) indicated by index d is set to 2.

The number of dimensions as used herein is the number of coordinate axes in the coordinate system that represents the positions of hand keypoints in a cropped image, such as the x-axis (x direction) and y-axis (y direction), that is, the number of coordinate elements that represent the positions.

In Equation (1), p_{sjd} indicates a detection position of a hand keypoint, more specifically, a one-dimensional coordinate representing the position of the hand keypoint. In other words, the position p_{sjd} is the d-th dimension (element) coordinate value representing the position of the j-th hand keypoint detected from the s-th cropped image. Furthermore, medianₛ(p_{sjd}) indicates the median value of all positions p_{sjd} obtained for a cropped image.

In Equation (1), the maximum value of the absolute values (deviations) of the differences between the positions p_{sjd} and the median value medianₛ(p_{sjd}) is calculated as the detection deviation δ.

The detection deviation δ thus obtained represents the deviation of the hand posture detected from the 20 cropped images, and a larger detection deviation δ represents a greater variability in the detection of the hand keypoint positions.

The calculation of the detection deviation δ is not limited to the example represented by Equation (1), and may be calculated by any other method. For example, the detection deviation δ may be calculated by an equation in which the median value medianₛ(p_{sjd}) and the maximum value max_{sjd} in Equation (1) are replaced with other aggregation functions.

When the detection deviation S is calculated for each set of evaluation data and hand keypoint detection model, then in step S13 in FIG. 3, the result of the detection deviation calculation is interpreted.

In the present technology, it is assumed that all the hand keypoint detection models utilize data augmentation for learning.

On the basis of this assumption, it is hypothesized that in scenes that are suited for hand keypoint detection models, stable detection will be possible even if weak data augmentation (weak perturbation) is applied to an input, and the result of detection deviation calculation is interpreted on the basis of this hypothesis.

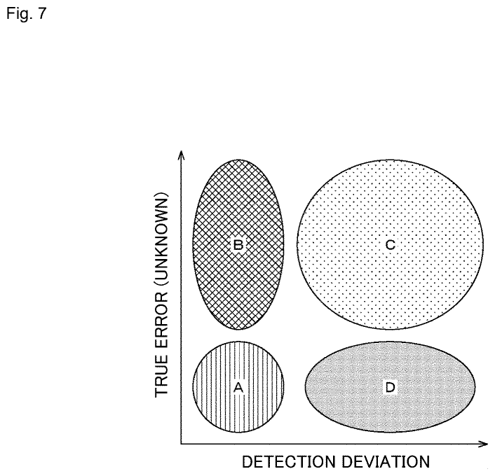

Specifically, the detection result interpretation unit 34 classifies combinations of evaluation data and hand keypoint detection models into one of four groups illustrated in FIG. 7.

In FIG. 7, the horizontal axis indicates the detection deviation δ, and the vertical axis indicates the error (true error) between the detection result of hand posture and the true hand posture. The cropped images essentially have no annotations, and therefore, this true error is unknown.

In an example illustrated in FIG. 7, each circular region represents a group to which combinations of evaluation data and hand keypoint detection models belong, and a letter within the region represents a group name.

For example, combinations (sets) of evaluation data and hand keypoint detection models, with a small detection deviation δ and a small true error belong to group A (hereinafter also referred to as A-determination).

In other words, the evaluation of the reliability (detection accuracy) and stability (low variance in detection results) of detection for these combinations indicates A-determination, which indicates an evaluation result of stable and correct detection (inference). In other words, for hand posture detection, a combination that has been determined as A-determination enables stable and correct detection.

Combinations of evaluation data and hand keypoint detection models, with a small detection deviation δ and a large true error belong to group B (hereinafter also referred to as B-determination).

B-determination indicates an evaluation result of stable but wrong detection (inference). For hand posture detection, a combination that has been determined as B-determination enables stable detection but does not enable correct detection, that is, provides wrong (incorrect) detection.

Combinations (sets) of evaluation data and hand keypoint detection models, with a large detection deviation δ and a large true error belong to group C (hereinafter also referred to as C-determination).

C-determination indicates an evaluation result of unstable and wrong detection (inference). For hand posture detection, a combination that has been determined as C-determination enables unstable detection and does not enable correct detection, that is, provides wrong (incorrect) detection.

Combinations (sets) of evaluation data and hand keypoint detection models, with a large detection deviation δ and a small true error belong to group D (hereinafter also referred to as D-determination).

For hand posture detection, a combination that has been determined as D-determination enables unstable but correct detection.

Since the evaluation result will never indicate D-determination, in reality (practically), combinations of evaluation data and hand keypoint detection model will be classified into three groups: A, B, and C. In other words, the detection result interpretation unit 34 determines the result of evaluation for each combination as either A-determination, B-determination, or C-determination.

In steps S13 and S20 in the model selection processing described with reference to FIG. 3, the detection deviation δ is used to sort (classify) the hand keypoint detection model.

Thus, the present technology focuses on a detection deviation δ to sort hand keypoint detection models. Therefore, in cases where the inference device 71 is used in a scene where the camera orientation or position is likely to change, or the subject is likely to change, that is, cases where a change (perturbation) is applied to an input, the sorting of hand keypoint detection models by the present technology is particularly effective.

The detection deviation δ is an index for evaluating the stability of detection when a slight change occurs in an input to a hand keypoint detection model, and is not an index for directly evaluating the accuracy of detection.

However, for example, when several hand keypoint detection models with a small detection deviation δ are selected and presented to the user, the user can select an appropriate hand keypoint detection model to be installed in the inference device 71 more easily and in a shorter time.

In the present technology, the result of interpretation for each combination of evaluation data and hand keypoint detection model, that is, the result of evaluation regarding the reliability and stability of detection, is also used to improve the correct/incorrect determination model and the hand keypoint detection model.

Improvement of the correct/incorrect determination model and the hand keypoint detection model will be described below.

In step S13 in the model selection processing in FIG. 3, the detection deviation δ is used to interpret (classify) the calculation result of the detection deviation for each combination of evaluation data and hand keypoint detection model.

In this case, for example, a combination with a small detection deviation δ belongs to either group A (A-determination) or group B (B-determination), but it is not possible to distinguish between A-determination and B-determination based on the detection deviation δ alone.

Therefore, the detection result interpretation unit 34 distinguishes between A-determination and B-determination by utilizing a user-based determination and a correct/incorrect determination model-based determination.

In particular, the user-based determination is used when the detection deviations δ of two different hand keypoint detection models for the same evaluation data are both small and the difference in the detection positions of the hand keypoints between those hand keypoint detection models is large.

For example, when the user-based determination is utilized, the display unit 22 displays, for the two hand keypoint detection models, cropped images and the detection results of the positions of the hand keypoints in the cropped images, that is, the detection results of the hand posture. More specifically, for example, the detection result of the hand posture (hand keypoints) is superimposed and displayed on each cropped image.

While viewing the display on the display unit 22, the user determines whether the displayed hand posture is correct or incorrect, and operates the input unit 21 to input the result of the determination. In other words, the user inputs whether to make A-determination or B-determination.

The user-based determination is whether the positions of all displayed hand keypoints are correct as a whole, that is, whether they have been detected correctly.

In this case, the user needs to do work (task) that visually checks the detection result of hand posture and input the determination result. However, this task takes less time than an annotation task of specifying the positions (locations) of all the hand keypoints one by one by operating a mouse or the like.

Therefore, even in the case of using a user-based determination (assistance), it is easier to sort an appropriate hand keypoint detection model compared to a general annotation task.

In the model sorting device 11, the result of the user-based determination is stored as learning data in the user-based determination storage area. Then, using this learning data, the correct/incorrect determination model learning unit 35 learns the correct/incorrect determination model. In other words, the result of the user-based determination is used to improve the correct/incorrect determination model.

When the user determines that the determination accuracy of the correct/incorrect determination model is sufficient, the user-based determination is switched to the correct/incorrect determination model-based determination.

In the correct/incorrect determination model-based determination, a cropped image, and the detection result of the positions of the hand keypoints from the cropped image, that is, the detection result of the hand posture, are used as an input to the correct/incorrect determination model, and a determination is made as to whether the detection result of the hand posture is correct or not, that is, a correct/incorrect determination is made.

In other words, the correct/incorrect determination model is used to determine whether to make A-determination or B-determination. In this case, if the result of the correct/incorrect determination indicates correct, it is determined as A-determination, and if the result of the correct/incorrect determination indicates incorrect, it is determined as B-determination. Using such a correct/incorrect determination model makes it possible to automatically distinguish between A-determination and B-determination without any user's assistance (determination).

The evaluation results, such as A-determination, B-determination, and C-determination, for each combination of evaluation data and hand keypoint detection model are also used to improve the hand keypoint detection model. Specifically, the evaluation results are used, for example, to add or screen learning data.

For example, consider the case where the evaluation of a combination of evaluation data and a hand keypoint detection model is determined as C-determination.

For the combination determined as C-determination, since the detection result of hand posture indicates unstable, the evaluation data of that combination is data poorly suited for the hand keypoint detection model. Therefore, adding such poor evaluation data to the learning data makes it possible to improve the hand keypoint detection model.

In this case, for example, if there is at least one hand keypoint detection model that has been determined as C-determination and there is at least one hand keypoint detection model that has been determined as A-determination among the model group, the detection result of the model that has been determined as A-determination is added to the learning data as a pseudo label.

In other words, if, among a plurality of (all) combinations of the same evaluation data and hand keypoint detection models, there are one or more hand keypoint detection models that have been determined as C-determination and there are one or more hand keypoint detection models that have been determined as A-determination, data including the evaluation data of the combinations that have been determined as A-determination and the detection results (inference results) of hand posture is added as learning data to the learning data storage area.

In contrast, for example, if the evaluation results of all the hand keypoint detection models included in the model group are either B-determination or C-determination, the evaluation data is data for which manual labeling is recommended.

In other words, if, among all the combinations of the same evaluation data and hand keypoint detection models, there is no combination that has been determined as A-determination, then the evaluation data is data for which manual labeling is recommended.

In this case, the evaluation data of which there is no combination that has been determined as A-determination is presented to the user as appropriate, and the user inputs (specifies) the positions of the hand keypoints. In other words, the user performs manual label assigning (manual labeling). Then, the data labeled by the user, that is, the data including the evaluation data and the positions of the hand keypoints, is added as learning data to the learning data storage area.

For example, if the evaluation of a combination of evaluation data and a hand keypoint detection model is determined as B-determination, the hand keypoint detection model is a model that can perform stable detection but cannot perform correct detection.

In such a case, the learning data used for learning of the hand keypoint detection model may contain inappropriate learning data, such as incorrectly labeled data, that is, data in which the positions of the hand keypoints are wrong.

Therefore, if there is a combination that has been determined as B-determination, the learning data stored in the learning data storage area is searched for data similar to the scene of the evaluation data of the combination that has been determined as B-determination, and the user is prompted (recommended) to reconfirm the learning data obtained by the search.

In other words, if, among a plurality of combinations of the same evaluation data and hand keypoint detection models, there is one or more combinations that have been determined as B-determination, learning data similar to the cropped image obtained from the evaluation data is identified from among the learning data already stored in the learning data storage area. The user is then prompted to reconfirm the identified learning data. The similar as referred to herein is determined on the basis of, for example, image similarity.

As described above, by classifying the combinations of evaluation data and hand keypoint detection models into either A-determination, B-determination, or C-determination, it is possible to effectively improve the learning data, that is, improve the hand keypoint detection models.

In particular, in this case, instead of adding all the pieces of evaluation data as learning data, only appropriate evaluation data is added as learning data. This means that instead of annotating all the pieces of data without annotation, annotation is performed only on data (scenes) where annotation is more effective. Therefore, the model sorting device 11 can improve the hand keypoint detection model more efficiently.

### <Description of Detection Deviation Calculation Processing>

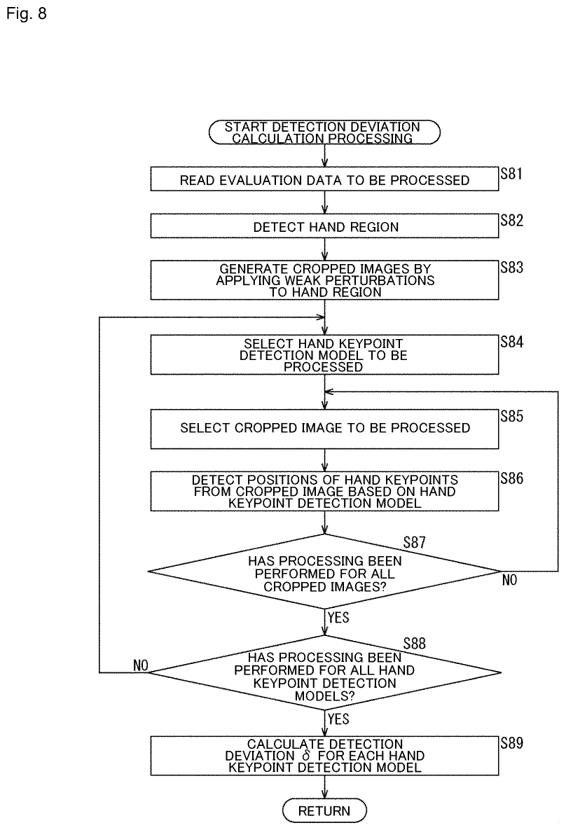

In step S12 in FIG. 3, processing illustrated in more detail in FIG. 8 is performed. The detection deviation calculation processing performed by the processing unit 24 will be described below with reference to a flowchart of FIG. 8.

In step S81, the hand region calculation unit 31 reads the evaluation data to be processed selected in step S11 in FIG. 3 from among the evaluation data supplied from the input unit 21.

In step S82, the hand region calculation unit 31 detects a hand region from the evaluation data to be processed on the basis of the hand region detection model stored in the storage unit 23. Specifically, the hand region calculation unit 31 inputs the evaluation data to the hand region detection model to perform a computation to detect a hand region in the image as the evaluation data.

In step S83, the inference unit 32 generates a predetermined number S of (a plurality of) cropped images by applying weak perturbations to the hand region based on the evaluation data to be processed and the detection result of the hand region in step S82.

For example, as described with reference to FIG. 5, the inference unit 32 generates cropped images by applying weak perturbations such as shift, scaling, and rotation to the hand region of the evaluation data and cutting out the hand region.

In step S84, the inference unit 32 selects one hand keypoint detection model to be processed from among the plurality of hand keypoint detection models stored in the storage unit 23.

In step S85, the inference unit 32 selects one cropped image to be processed from among the S cropped images generated in step S83.

In step S86, the inference unit 32 detects the positions of the hand keypoints from the cropped image to be processed, based on the hand keypoint detection model to be processed. Specifically, using the cropped image as an input to the hand keypoint detection model, and a computation is performed to calculate the positions of the plurality of hand keypoints.

In step S87, the inference unit 32 determines whether or not the processing of detecting the positions of the hand keypoints has been performed for all the S cropped images.

If it is determined in step S87 that the processing has not yet been performed for all the cropped images, the processing returns to step S85 to repeat the above-described processing. Thus, the next cropped image is selected as the processing target to detect the positions of the hand keypoints.

On the other hand, if it is determined in step S87 that the processing has been performed for all the cropped images, then in step S88, the inference unit 32 determines whether or not the processing of detecting the positions of the hand keypoints has been performed for all the hand keypoint detection models.

If it is determined in step S88 that the processing has not yet been performed for all the hand keypoint detection models, the processing returns to step S84 to repeat the above-described processing. Thus, based on the hand keypoint detection model that is newly selected as the processing target, the positions of the hand keypoints are detected from each of the S cropped images.

On the other hand, if it is determined in step S88 that the processing has been performed for all the hand keypoint detection models, the processing of step S89 is then performed.

In step S89, the detection deviation calculation unit 33 calculates a detection deviation δ for each hand keypoint detection model based on the positions of the hand keypoints detected from the cropped images by the hand keypoint detection model, that is, the detection results of the hand posture. For example, in step S89, a detection deviation δ is calculated for each hand keypoint detection model by calculating the above-described Equation (1).

When the detection deviation δ is calculated, the detection deviation calculation processing ends, and then the processing proceeds to step S13 in FIG. 3.

As described above, the processing unit 24 generates cropped images by applying weak perturbations to the evaluation data, and calculates the detection deviation δ based on the detection results of the positions of the hand keypoints from the cropped images. In this way, a detection deviation δ can be obtained, which serves as an index for evaluating the stability of detection.

<Description of Correct/Incorrect Determination Processing Based on User's Determination>. In step S13 of the model selection processing in FIG. 3, the result of the detection deviation calculation is interpreted as described above, specifically, either interpretation based on a user's determination, that is, interpretation using a user's assistance, or interpretation based on a correct/incorrect determination model, is performed.

In particular, when it is determined that the determination accuracy of a correct/incorrect determination model is insufficient, interpretation is performed on the basis of a user's determination in step S13, and when the user determines that the determination accuracy of a correct/incorrect determination model is sufficient, interpretation is switched to interpretation based on the correct/incorrect determination model.

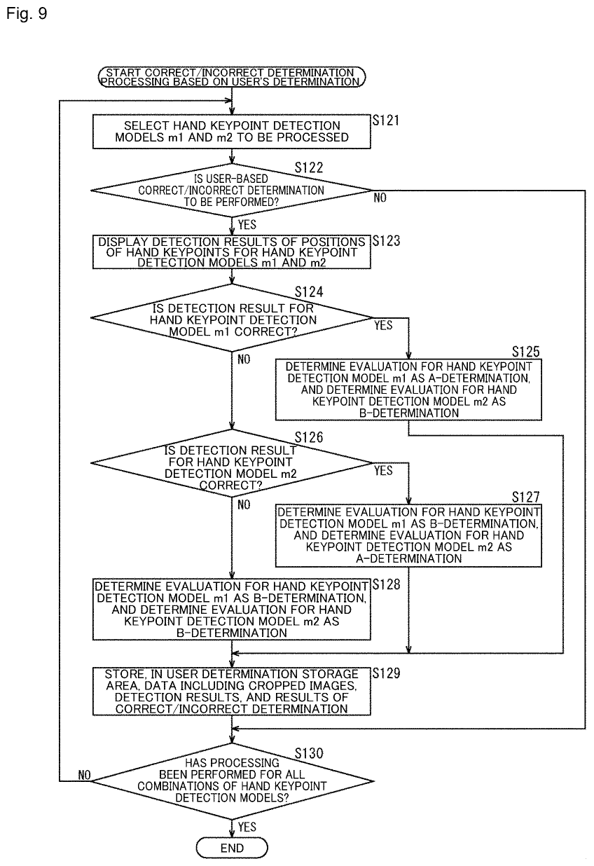

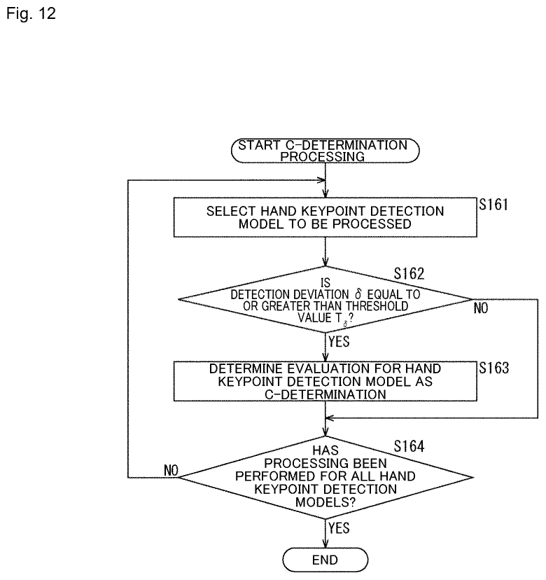

When interpretation based on a user's determination, that is, interpretation based on a user's assistance, is performed in step S13, specifically, for example, the processing in step S13 to be performed includes correct/incorrect determination processing based on a user's determination illustrated in FIG. 9 and C-determination processing illustrated in FIG. 12.

First, the correct/incorrect determination processing based on a user's determination, which is performed by the detection result interpretation unit 34, will be described with reference to a flowchart of FIG. 9.

In step S121, the detection result interpretation unit 34 selects, from among the plurality of hand keypoint detection models stored in the storage unit 23, two hand keypoint detection models m1 and m2 to be processed.

A detection deviation δ obtained for a combination of the evaluation data to be processed and the hand keypoint detection model m1 will now be referred to as a detection deviation δₘ₁. Similarly, a detection deviation δ obtained for a combination of the evaluation data to be processed and the hand keypoint detection model m2 will now be referred to as a detection deviation δₘ₂.

In step S122, the detection result interpretation unit 34 determines whether or not to perform a user-based correct/incorrect determination based on the detection deviation δₘ₁ and the detection deviation δₘ₂.

For example, when a detection deviation δ for a hand keypoint detection model and a detection result of the positions of hand keypoints satisfy the following Equation (2), the detection result interpretation unit 34 determines to perform a user-based correct/incorrect determination.

$$\begin{matrix}[ Math . 2 ] & \\ {δ}_{m 1} < {T}_{δ} ∧ {δ}_{m 2} < {T}_{δ} ∧ \frac{1}{J} {\sum }_{j = 0}^{J} ‖ {p}_{m 1 , j} - {p}_{m 2 , j} ‖ > {T}_{p} & ( 2 )\end{matrix}$$

In Equation (2), T₆ and Tₚ represent a threshold value for the detection deviation δ and a threshold value for the detection positions of the hand keypoints.

p_{m1,j} and p_{m2,j} indicate the position of the j-th hand keypoint detected by hand keypoint detection model m1, and the position of the j-th hand keypoint detected by hand keypoint detection model m2. The average value of the absolute differences between positions p_{m1,j} and positions p_{m2,j} in Equation (2) can be said to be the difference between the positions of the hand keypoints (inference results).

In Equation (2), when the detection deviation δₘ₁ is smaller (less than) a threshold value T_{δ}, and the detection deviation δₘ₂ is also smaller than the threshold value T_{δ}, and the average value of absolute differences between positions p_{m1,j} and p_{m2,j} of corresponding hand keypoints is greater than a threshold value Tₚ, it is determined that a user-based correct/incorrect determination is to be performed.

The conditions represented in Equation (2) are satisfied, that is, Equation (2) holds, when the detection deviations δ for the two hand keypoint detection models (combinations) to be processed are both small, and the difference between the detection positions (inference results) of the hand keypoints in the hand keypoint detection models is large.

When Equation (2) holds, the detection deviations δ for the two hand keypoint detection models are both small, so that the evaluation of the combination of each of the hand keypoint detection models and the evaluation data indicates either A-determination or B-determination.

When Equation (2) holds, the difference between the detection positions of the hand keypoints is large, so that the evaluation of the combination of at least one of the two hand keypoint detection models and the evaluation data will indicate B-determination. In other words, at least one of the positions p_{m1,j} and p_{m2,j} will be an incorrect position. Therefore, when Equation (2) holds, it is determined in step S122 that a user-based correct/incorrect determination is to be performed.

If it is determined in step S122 that a user-based correct/incorrect determination is not to be performed, the processing of steps S123 to S129 is not performed, and then the processing proceeds to step S130.

In this case, the combination of the hand keypoint detection model to be processed and the evaluation data will remain in a state where evaluation (interpretation) such as A-determination or B-determination is not performed until the accuracy of the correct/incorrect determination model is determined to be sufficient.

For example, when the average value of absolute differences between the positions of the hand keypoints in Equation (2) is equal to or smaller than the threshold value Tₚ and the detection positions of the hand keypoints in the two hand keypoint detection models are close to each other, it is difficult for the user to make an accurate visual correct/incorrect determination. Therefore, in such a case, it is determined in step S122 that a user-based correct/incorrect determination is not to be performed, and after it is determined that the accuracy of the correct/incorrect determination model is sufficient, a correct/incorrect determination is performed on the basis of the correct/incorrect determination model.

On the other hand, if it is determined in step S122 that a user-based correct/incorrect determination is to be performed, then the processing proceeds to step S123.

In step S123, the detection result interpretation unit 34 controls the display unit 22 to cause the display unit 22 to display the detection results of the positions of the hand keypoints for the two hand keypoint detection model m1 and hand keypoint detection model m2, which are to be processed.

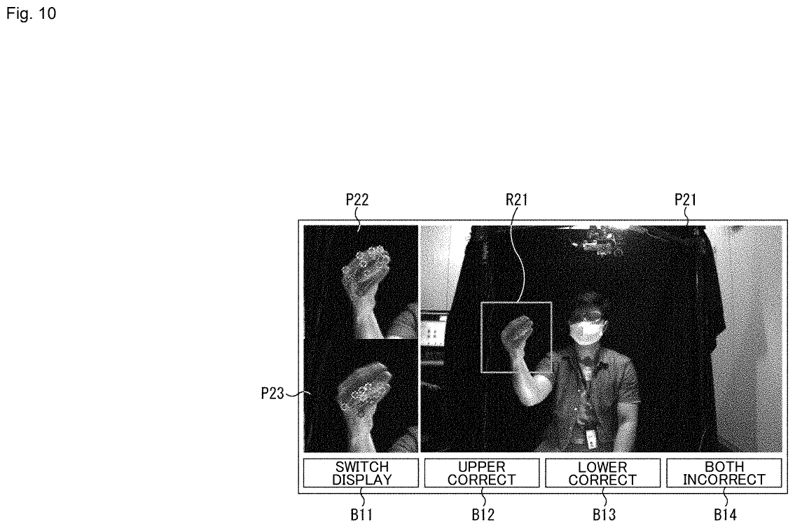

As a result, the display unit 22 displays, for example, a screen as illustrated in FIG. 10.

In an example illustrated in FIG. 10, an image P21 which is the evaluation data to be processed, more specifically, an image P21 based on the evaluation data, is displayed. This image P21 is the original evaluation data before cropping.

A rectangular frame R21 (hereinafter also referred to as a hand region R21) indicating the hand region detected in step S82 in FIG. 8 is superimposed and displayed on the image P21. The hand region R21 indicates a region to be detected for hand keypoints based on a hand keypoint detection model, that is, the detection result of the region of the hand, which is the subject to be inferred.

The hand keypoints detected by one of the two hand keypoint detection models to be processed are superimposed and displayed on a portion of the hand region R21. In other words, the detection result (inference result) of the hand keypoint positions is superimposed and displayed on the portion of the hand region R21.

On the left side in the figure of the image P21, a cropped image P22 and a cropped image P23 that are generated on the basis of the image P21, more specifically, a cropped image P22 and a cropped image P23 that are based on image data generated on the basis of the evaluation data are displayed side by side.

For example, the cropped image P22 is determined to be a cropped image having the largest deviation of the detection positions of the hand keypoints for the hand keypoint detection model m1 among the S cropped images generated from the image P21 in step S83 in FIG. 8. The deviation as referred to herein, for example, the absolute value of the difference between the position p_{sjd} and the median value medianₛ (p_{sjd}) in Equation (1).

The hand keypoints detected from the cropped image P22 based on the hand keypoint detection model m1 are superimposed and displayed on the cropped image P22. In other words, the detection result (inference result) of the positions of the hand keypoints for the hand keypoint detection model m1 is superimposed and displayed on the cropped image P22.

Similarly, the cropped image P23 is determined to be a cropped image having the largest deviation of the detection positions of the hand keypoints for the hand keypoint detection model m2 among the S cropped images generated from the image P21 in step S83 in FIG. 8. The detection result of the positions of the hand keypoints from the cropped image P23 based on the hand keypoint detection model m2 is displayed on the cropped image P23.

In this way, superimposing the detection results of the hand keypoint positions for the two hand keypoint detection models on the cropped images enables the user to easily visually determine whether or not each of the detection results of the positions of the hand keypoints is correct. For example, in this example, it is clear that there is a misalignment between the hand, which is the subject in the cropped image P23, and the positions of the hand keypoints superimposed and displayed, and therefore the detection result is incorrect.

When weak perturbations in color and background are applied to the image P21, which is the evaluation data, the display of colors and backgrounds of at least the two cropped images P22 and P23 differ from each other, making it easy to understand that weak perturbations in color and background have been applied.

Furthermore, in the example illustrated in FIG. 10, buttons B11 to B14 are provided on the display screen.

The button B11 is a display switching button, and the user can operate the button B11 to switch the detection result of the hand keypoint positions to be superimposed and displayed on a portion of the hand region R21 of the image P21, which is the evaluation data.

Specifically, by operating the button B11, the user can switch between superimposing the detection result displayed in the cropped image P22 on the portion of the hand region R21, and superimposing the detection result displayed in the cropped image P23 on the portion of the hand region R21.

In other words, the user can switch between displaying the detection result for the hand keypoint detection model m1 and displaying the detection result for the hand keypoint detection model m2 in the hand region R21.

In particular, in this case, the size, orientation, position, etc. of the hand region R21 (rectangular frame) may be changed depending on whether the detection result displayed in the cropped image P22 is to be displayed or the detection result displayed in the cropped image P23 is to be displayed, that is, depending on the perturbation added when generating the cropped image. In other words, the hand region R21 may be displayed with a size, orientation, and position depending on the perturbation applied when generating the cropped image. This allows the user to understand that a weak perturbation has been applied when generating the cropped image, and what kind of perturbation has been applied.

In addition, superimposing the detection result of the positions of the hand keypoints on the image P21, which is the original evaluation data, makes it possible to more easily perform a user-based correct/incorrect determination.

The buttons B12 to B14 are buttons for the user to input the result of a correct/incorrect determination for the detection result of the hand keypoint positions superimposed and displayed on the cropped image P22 or the cropped image P23.

Specifically, the button B12 is a button that is operated when the user determines (decides) that the detection result displayed in the cropped image P22 is correct and that the detection result displayed in the cropped image P23 is incorrect (wrong).

The button B13 is a button that is operated when the user determines that the detection result displayed in the cropped image P22 is incorrect and that the detection result displayed in the cropped image P23 is correct.

The button B14 is a button that is operated when the user determines that the detection result displayed in the cropped image P22 is incorrect and that the detection result displayed in the cropped image P23 is also incorrect.

The user visually checks the image P21, the cropped image P22, and the cropped image P23 to perform a correct/incorrect determination of whether the detection result for each of the hand keypoint detection model m1 and the hand keypoint detection model m2 is correct or not. Then, the user operates a mouse or keyboard serving as the input unit 21, and operates any one of the buttons B12 to B14 in accordance with the result of the user's own correct/incorrect determination, thereby inputting the result of the correct/incorrect determination. Accordingly, a signal corresponding to the user's operation is supplied from the input unit 21 to the processing unit 24.

As described above, the detection result interpretation unit 34 causes the display unit 22 to display the display screen illustrated in FIG. 10, thereby allowing the user to select A-determination or B-determination as the evaluation result for a combination of evaluation data and a hand keypoint detection model.

Referring to FIG. 10, an example has been described in which the detection results of the hand keypoint positions for two hand keypoint detection models (two combinations) are arranged side by side, and a correct/incorrect determination is performed for each of their two detection results. However, without limited to this, three or more detection results may be arranged and a correct/incorrect determination may be performed for each of their three or more detection results. In such a case, the user selects the correct one from a plurality of detection results, for example, three or more.

Returning to the explanation of the flowchart in FIG. 9, after the detection result is displayed in step S123 and then the user inputs the result of the correct/incorrect determination, the processing of step S124 is then performed.

In subsequent steps S124 to S128, the detection result interpretation unit 34 determines the evaluation result for each combination of evaluation data and hand keypoint detection model as either A-determination or B-determination, based on an input operation by the user.

In step S124, the detection result interpretation unit 34 determines whether or not the detection result for the hand keypoint detection model m1 is correct, based on a signal supplied from the input unit 21 in response to a user operation.

For example, when the user operates the button B12 on the screen illustrated in FIG. 10, it is determined that the detection result for the hand keypoint detection model m1 is correct.

If it is determined in step S124 that the detection result for the hand keypoint detection model m1 is correct, the processing of step S125 is then performed.

In step S125, the detection result interpretation unit 34 determines the evaluation of the combination of the hand keypoint detection model m1 and the evaluation data as A-determination, and determines the evaluation of the combination of the hand keypoint detection model m2 and the evaluation data as B-determination. When the processing of step S125 has been performed, then the processing proceeds step S129.

If it is determined in step S124 that the detection result for the hand keypoint detection model m1 is incorrect, the detection result interpretation unit 34 determines in step S126 whether the detection result for the hand keypoint detection model m2 is correct or not.

For example, when the user operates the button B13 on the screen illustrated in FIG. 10, it is determined that the detection result for the hand keypoint detection model m2 is correct.

If it is determined in step S126 that the detection result for the hand keypoint detection model m2 is correct, the processing of step S127 is then performed.

In step S127, the detection result interpretation unit 34 determines the evaluation of the combination of the hand keypoint detection model m1 and the evaluation data as B-determination, and determines the evaluation of the combination of the hand keypoint detection model m2 and the evaluation data as A-determination. When the processing of step S127 has been performed, then the processing proceeds step S129.

If it is determined in step S126 that the detection result for the hand keypoint detection model m2 is incorrect, the processing of step S128 is then performed.

In this case, the user-based correct/incorrect determination indicates that the detection results of both the hand keypoint detection model m1 and the hand keypoint detection model m2 are incorrect, and accordingly, for example, on the screen illustrated in FIG. 10, the user operates the button B14.

In step S128, the detection result interpretation unit 34 determines the evaluation of the combination of the hand keypoint detection model m1 and the evaluation data as B-determination, and determines the evaluation of the combination of the hand keypoint detection model m2 and the evaluation data as B-determination.

When the processing of step S125, step S127, or step S128 has been performed, the processing of S129 is then performed.

In step S129, for the hand keypoint detection model m1 and hand keypoint detection model m2, which are to be processed, the detection result interpretation unit 34 supplies, as learning data, data including the cropped images, the detection results of the hand keypoint positions for the cropped images, and the results of user-based correct/incorrect determination to the user determination storage area of the storage unit 23 for storage (save) therein.

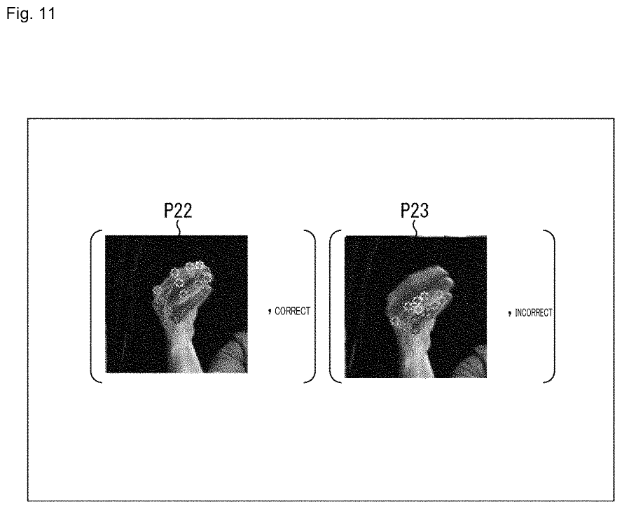

For example, when the button B12 is operated on the display screen illustrated in FIG. 10 and it is determined that the detection result for the hand keypoint detection model m1 is correct, that is, when the processing of step S125 is performed, learning data illustrated in FIG. 11 is added to the user determination storage area. In FIG. 11, parts corresponding to those in FIG. 10 are indicated by the same reference numerals, and the description of those parts will be omitted as appropriate.

In this example, for the hand keypoint detection model m1, learning data is stored that includes the cropped image P22, the detection result of the hand keypoint positions from the cropped image P22 for the hand keypoint detection model m1, and information indicating “correct” as the result of a correct/incorrect determination input by the user.

In addition, for the hand keypoint detection model m2, learning data is stored that includes the cropped image P23, the detection result of the hand keypoint positions from the cropped image P23 for the hand keypoint detection model m2, and information indicating “incorrect” as the result of a correct/incorrect determination input by the user.

Such learning data being used enables a correct/incorrect determination model to be obtained using as inputs a cropped image and a detection result (inference result) of hand keypoint positions in the cropped image, and outputting the result of a correct/incorrect determination of the detection result of the hand keypoint positions.

Returning to the explanation of the flowchart in FIG. 9, when the processing of step S129 has been performed, or if it is determined in step S122 that a user-based correct/incorrect determination is not to be performed, the processing of step S130 is then performed.

In step S130, the detection result interpretation unit 34 determines whether or not the processing has been performed for all the combinations of the hand keypoint detection models.

If it is determined in step S130 that the processing has not yet been performed for all the combinations, then the processing returns to step S121 to repeat the above-described processing.

On the other hand, if it is determined in step S130 that the processing has been performed for all the combinations, the correct/incorrect determination processing based on a user's determination ends.

In step S130, the processing of steps S121 to S129 may be performed for all the combinations of two hand keypoint detection models for all the hand keypoint detection models stored in the storage unit 23.

In this case, if there is any hand keypoint detection model among the two hand keypoint detection models to be processed for which a user-based correct/incorrect determination has already been performed, the result of the user-based correct/incorrect determination for the hand keypoint detection model may be displayed on the display screen illustrated in FIG. 10.

In addition, for example, a hand keypoint detection model that has been processed once and for which a user-based correct/incorrect determination has already been performed may be excluded from the candidates for processing in the subsequent step S121, that is, it may be excluded from selection.

As described above, the detection result interpretation unit 34 evaluates each combination of hand keypoint detection model and evaluation data (interprets the result of the detection deviation calculation) while utilizing a user's determination as an assistance, and accumulates learning data for the correct/incorrect determination model as appropriate.

In particular, in the correct/incorrect determination processing based on a user's determination, a user-based correct/incorrect determination is performed only when there is a large difference in the detection positions of hand keypoints between two hand keypoint detection models to be processed, more specifically, only when Equation (2) holds.

In this way, the number of times the user performs a visual correct/incorrect determination, that is, the frequency with which a user-based correct/incorrect determination is made, can be reduced, and therefore, the burden on the user can be reduced.

### <Description of C-determination Processing>

When interpretation based on a user's determination is performed as the processing of step S13 in FIG. 3, then in step S13, C-determination processing illustrated in FIG. 12 is also performed in addition to the correct/incorrect determination processing based on a user's determination described with reference to FIG. 9.

The C-determination processing performed by the detection result interpretation unit 34 will be described below with reference to a flowchart of FIG. 12.

In step S161, the detection result interpretation unit 34 selects one hand keypoint detection model to be processed from among the plurality of hand keypoint detection models stored in the storage unit 23.

In step S162, the detection result interpretation unit 34 determines whether or not the detection deviation δ calculated in step S89 in FIG. 8 for a combination of the hand keypoint detection model to be processed and the evaluation data is equal to or greater than the above-described threshold value T_{δ}.

For example, as described with reference to FIG. 7, among the combinations of hand keypoint detection models and evaluation data, those with a large detection deviation δ are determined as C-determination because the detection of the hand keypoint positions by the hand keypoint detection models of those combinations is unstable.

If it is determined in step S162 that the detection deviation δ is less than the threshold value T_{δ}, the processing of step S163 is not performed, and then the processing proceeds to step S164.

In this case, the evaluation of the combination of the hand keypoint detection model to be processed and the evaluation data should be determined as A-determination or B-determination, and the processing of steps S122 to S129 in FIG. 9 is performed for such a combination.

On the other hand, if it is determined in step S162 that the detection deviation δ is equal to or greater than the threshold value T_{δ}, then in step S163, the detection result interpretation unit 34 determines the evaluation of the combination of the hand keypoint detection model to be processed and the evaluation data as C-determination.

When the processing of step S163 has been performed, or if it is determined in step S162 that the detection deviation δ is less than the threshold value T_{δ}, the processing of step S164 is then performed.

In step S164, the detection result interpretation unit 34 determines whether or not the processing has been performed for all the hand keypoint detection models.

If it is determined in step S164 that the processing has not yet been performed for all the hand keypoint detection models, the processing returns to step S161 to repeat the above-described processing. Thus, for the hand keypoint detection model that is newly selected as the processing target, the detection deviation δ is compared with the threshold value T_{δ}.

On the other hand, if it is determined in step S164 that the processing has been performed for all the hand keypoint detection models, the C-determination processing ends.

As described above, the detection result interpretation unit 34 interprets whether the evaluation of the combination of the hand keypoint detection model and the evaluation data is C-determination based on the detection deviation δ.

By using the detection deviation δ as an index in this way, the C-determination can be interpreted without requiring a user's determination (assistance).

The result of evaluation of a combination of a hand keypoint detection model and evaluation data, such as A-determination or C-determination, performed in the correct/incorrect determination processing based on a user-determination in FIG. 9 or the C-determination processing in FIG. 12, is used in step S14 (learning data addition processing) and step S15 (screening processing) in FIG. 3.

### <Description of Correct/Incorrect Determination Processing Based on Correct/Incorrect Determination Model>

In the model selection processing in FIG. 3, when the processing of steps S11 to S17 is repeated, learning data for the correct/incorrect determination model is accumulated in the user determination storage area, and when a certain amount of learning data is obtained, it becomes possible to learn the correct/incorrect determination model.

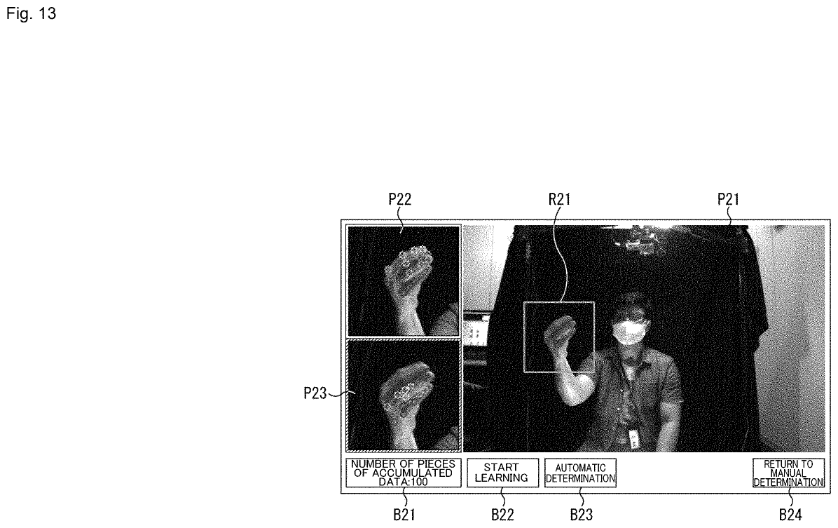

When the model selection processing in FIG. 3, particularly the processing of steps S11 to S17, is being performed, the user can appropriately operate the input unit 21 to cause the display unit 22 to display, for example, a display screen illustrated in FIG. 13. In other words, the detection result interpretation unit 34 causes the display unit 22 to display the display screen illustrated in FIG. 13 in response to an operation by the user.

In FIG. 13, parts corresponding to those in FIG. 10 are indicated by the same reference numerals, and the description those parts will be omitted as appropriate.

In the example of FIG. 13, an image P21 which is the evaluation data to be processed is displayed, and a hand region R21 is superimposed and displayed in a rectangular frame on the image P21. In particular, in the hand region R21, hand keypoints detected by the hand keypoint detection model to be processed are superimposed and displayed, similar to the example of FIG. 10.

On the left side in the figure of the image P21, as in FIG. 10, a cropped image P22 on which the detection result of hand keypoint positions for the hand keypoint detection model m1 is superimposed, and a cropped image P23 on which the detection result of hand keypoint positions for the hand keypoint detection model m2 is superimposed, are displayed side by side.

In particular, in this example, in each portion of the cropped image P22 and the cropped image P23, the result of a correct/incorrect determination model-based correct/incorrect determination of the detection result (inference result) of the hand keypoint positions for the corresponding hand keypoint detection model is also displayed.

Specifically, the entire cropped image P22 is surrounded by a frame of a color indicating that the determination result for the correct/incorrect determination model indicates “correct”. In contrast, the cropped image P23 is surrounded by a frame in a color indicating that the determination result for the correct/incorrect determination model indicates “incorrect”.

In this way, displaying the detection results of the hand keypoint positions in the cropped images as well as the results of the correct/incorrect determination model-based correct/incorrect determinations enables the user to easily determine whether the correct/incorrect determination models are sufficiently reliable, that is, whether they have achieved sufficient accuracy.

The result of a correct/incorrect determination may be displayed in any other manner, such as by color or other display form, or by using correct/incorrect letters or marks.

In the example illustrated in FIG. 13, buttons B21 to B24 are provided on the display screen.

The button B21 is for confirming the number of pieces of learning data for the correct/incorrect determination model that are accumulated (saved) in the user determination storage area of the storage unit 23, and the number of pieces of learning data is displayed on the button B21. For example, by operating the button B21, details regarding the accumulated pieces of learning data, such as the number of pieces of learning data and cropped images, may be confirmed, or the button B21 may not function as an actual button and may be a region that displays only the number of pieces of learning data.

The button B22 is a button for instructing the start of learning of the correct/incorrect determination model, that is, execution of learning.

For example, when the user confirms the display of the button B21 and the like and determines that a sufficient amount of learning data has been obtained, the user operates the button B22 on the display screen by operating the input unit 21 to instruct execution of learning. Accordingly, in step S16 of the model selection processing in FIG. 3, the correct/incorrect determination model learning unit 35 learns the correct/incorrect determination model based on the learning data stored in the user determination storage area of the storage unit 23.

The button B23 is a button for interpreting the result of detection deviation calculation, that is, for evaluating the combination of the evaluation data and the hand keypoint detection model based on the correct/incorrect determination model.

For example, the user operates the button B23 when the user determines that the correct/incorrect determination model has been sufficiently learned, that is, that the correct/incorrect determination model with sufficient accuracy has been obtained, by referring to the correct/incorrect determination results displayed as well as the cropped image P22 and the cropped image P23.

Accordingly, in step S13 of the model selection processing in FIG. 3 which is performed thereafter, the correct/incorrect determination model is used to interpret the result of detection deviation calculation.

The button B24 is a button for returning the interpretation of the result of detection deviation calculation, that is, the evaluation of the combination of the evaluation data and the hand keypoint detection model from a state in which it is performed on the basis of the correct/incorrect determination model to a state in which it is performed on the basis of a user's determination.

For example, when the user determines that the accuracy of the correct/incorrect determination model is insufficient while the result of detection deviation calculation is interpreted using the correct/incorrect determination model, the user can operate the button B24 to interpret the result of detection deviation calculation based on a user's determination.

When the user operates the button B24, thereafter, in step S13 of the model selection processing in FIG. 3, the correct/incorrect determination processing based on a user's determination in FIG. 9 and the C-determination processing in FIG. 12 are performed to interpret the results of detection deviation calculation based on a user's determination.

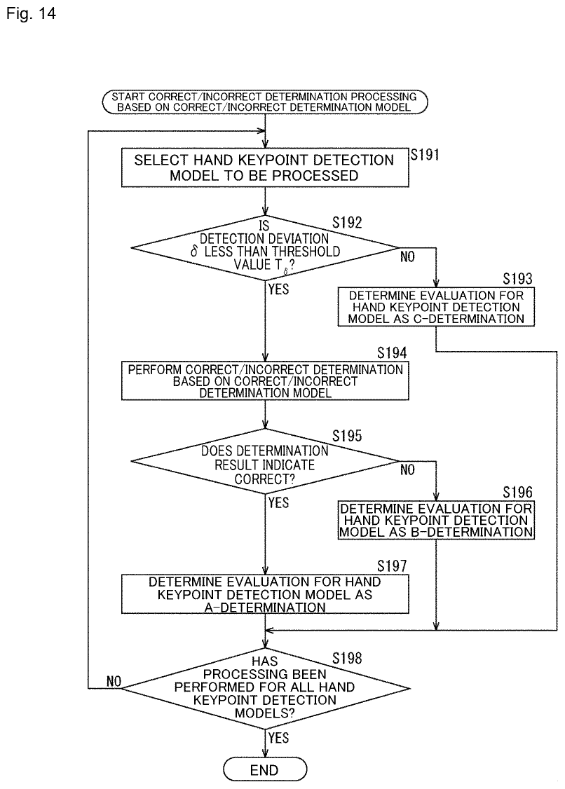

When the button B23 is operated as described above, thereafter, in step S13 of the model selection processing in FIG. 3, processing using the correct/incorrect determination model is performed. Specifically, for example, in step S13, processing illustrated in FIG. 14 is performed.

The correct/incorrect determination processing based on the correct/incorrect determination model, which is performed by the detection result interpretation unit 34, will be described below with reference to a flowchart of FIG. 14. In this correct/incorrect determination processing, an evaluation is performed on a combination of evaluation data and a hand keypoint detection model based on a cropped image, a detection result of hand keypoint positions, a correct/incorrect determination model, and a detection deviation δ.

In step S191, the detection result interpretation unit 34 selects one hand keypoint detection model to be processed from among the plurality of hand keypoint detection models stored in the storage unit 23.

In step S192, the detection result interpretation unit 34 determines whether or not the detection deviation δ calculated in step S89 in FIG. 8 for a combination of the hand keypoint detection model to be processed and the evaluation data is less than the above-described threshold value T_{δ}.

If it is determined in step S192 that the detection deviation δ is not less than the threshold value T_{δ}, that is, if it is determined that the detection deviation δ is equal to or greater than the threshold value T_{δ}, the processing of step S193 is then performed.

In step S193, the detection result interpretation unit 34 determines the evaluation of the combination of the hand keypoint detection model to be processed and the evaluation data as C-determination. After the processing of step S193, the process advances to step S198.

On the other hand, if it is determined in step S192 that the detection deviation δ is less than the threshold value T_{δ}, the processing of step S194 is then performed.

In step S194, the detection result interpretation unit 34 performs a correct/incorrect determination based on the correct/incorrect determination model stored in the storage unit 23.

For example, the detection result interpretation unit 34 uses, as inputs to a correct/incorrect determination model, the cropped image, the detection result of the hand keypoint positions from the cropped image for the hand keypoint detection model, obtained for the combination of the hand keypoint detection model to be processed and the evaluation data.

In this case, the cropped image as an input is, for example, among the S cropped images generated in step S83 in FIG. 8, the cropped image that has the largest deviation in the detection positions of hand keypoints for the hand keypoint detection model, that is, the largest absolute value of the difference between the position p_{sjd} and the median value medianₛ(p_{sjd}) in Equation (1).

The detection result interpretation unit 34 performs calculations based on the correct/incorrect determination model, and the cropped image and detection result of the hand keypoint positions as inputs, thereby performing a correct/incorrect determination model-based correct/incorrect determination. As a result, the determination result thus obtained indicates either “correct” meaning that the detection result of the hand keypoint positions is correct, or “incorrect” meaning that the detection result of the hand keypoint positions is incorrect.

In step S195, the detection result interpretation unit 34 determines whether the determination result of the correct/incorrect determination in step S194 indicates “correct” or not.

If it is determined in step S195 that the determination result does not indicate “correct”, that is, that the determination result indicates “incorrect”, then in step S196, the detection result interpretation unit 34 determines the evaluation of the combination of the hand keypoint detection model to be processed and the evaluation data as B-determination. After the processing of step S196, the process advances to step S198.

On the other hand, if it is determined in step S195 that the determination result indicates “correct”, then in step S197, the detection result interpretation unit 34 determines the evaluation of the combination of the hand keypoint detection model to be processed and the evaluation data as A-determination. When the processing of step S197 has been performed, then the processing proceeds step S198.

When the processing of step S193, step S196, or step S197 has been performed, the processing of S198 is then performed.

In step S198, the detection result interpretation unit 34 determines whether or not the processing has been performed for all the hand keypoint detection models.

If it is determined in step S198 that the processing has not yet been performed for all the hand keypoint detection models, the processing returns to step S191 to repeat the above-described processing. Specifically, an evaluation is performed on a combination of the hand keypoint detection model that is newly selected as the processing target and the evaluation data to be processed.

On the other hand, if it is determined in step S198 that the processing has been performed for all the hand keypoint detection models, the correct/incorrect determination processing based on the correct/incorrect determination model ends.

As described above, the detection result interpretation unit 34 evaluates each combination of hand keypoint detection model and evaluation data based on the correct/incorrect determination model, that is, interprets the result of the detection deviation calculation. The correct/incorrect determination model being used makes it possible to evaluate all the combinations of hand keypoint detection models and the evaluation data without requiring a user's determination (assistance).

### <Description of Learning Data Addition Processing>

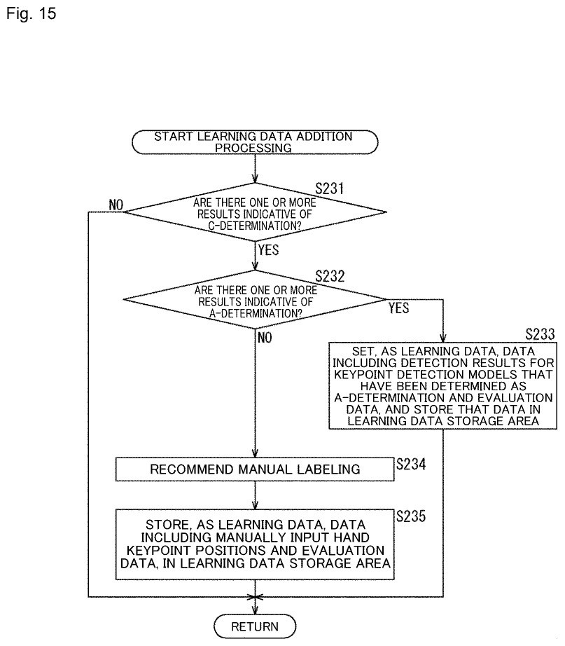

Next, the learning data addition processing corresponding to the processing of step S14 in FIG. 3 will be described with reference to a flowchart in FIG. 15.

In step S231, the model improvement unit 36 determines whether or not, among the evaluation results (determination results) of the combinations of the evaluation data to be processed and the hand keypoint detection models, obtained by the processing of step S13 in FIG. 3, there are one or more results indicative of C-determination.

If it is determined in step S231 that there is no result indicative of C-determination, the evaluation data to be processed is not data poorly suited for the hand keypoint detection model, so that the processing of steps S232 to S235 is not performed, and then the learning data addition processing ends.

On the other hand, if it is determined in step S231 that there are one or more results indicative of C-determination, the processing proceeds to step S232.

In step S232, the model improvement unit 36 determines whether or not, among the evaluation results of the combinations of the evaluation data to be processed and the hand keypoint detection models, obtained by the processing of step S13 in FIG. 3, there are one or more results indicative of A-determination.

If it is determined in step S232 that there are one or more results indicative of A-determination, the processing of step S233 is then performed.

In step S233, the model improvement unit 36 sets, as learning data, data including the detection results of the hand keypoint positions for the hand keypoint detection models of the combinations that have been determined as A-determination and the evaluation data to be processed, and stores the data in the learning data storage area of the storage unit 23.

More specifically, the detection result of the hand keypoint positions for the hand keypoint detection model is expressed as coordinates indicating the positions in the cropped image. In contrast, the hand keypoint detection model is learned using evaluation data rather than cropped images.

Accordingly, the model improvement unit 36 converts the coordinates indicating the detection result of the hand keypoint positions in the cropped image into coordinates on the image as the evaluation data to be processed corresponding to the cropped image. The model improvement unit 36 then supplies, as learning data (pseudo label), data including the coordinates (position information) indicating the converted positions and the evaluation data to the learning data storage area of the storage unit 23 for storage (accumulation) therein.

As described above, evaluation data with one or more results indicative of C-determination is data of a scene that is poorly suited for hand keypoint detection models. Therefore, adding such evaluation data as learning data makes it possible to obtain a hand keypoint detection model that is more suitable for use in the environment in which the evaluation data was captured.

In this case, to use the evaluation data for learning, reliable detection results of the positions of hand keypoints in the evaluation data are required. However, since the detection results of the positions of hand keypoints for combinations that have been determined as A-determination are reliable, appropriate learning data can be obtained.

When the processing of step S233 has been performed to add the learning data, then the learning data addition processing ends.

If it is determined in step S232 that there is no result indicative of A-determination, then in step S234, the model improvement unit 36 recommends manual labeling to the user.

If it is determined that there is no result indicative of A-determination, there is no reliable detection result of hand keypoint positions for the evaluation data wished to be added as learning data.

Therefore, the model improvement unit 36 supplies the evaluation data to the display unit 22 and displays an image as the evaluation data as appropriate, and prompts (recommends) the user to perform manual labeling, that is, to manually input correct hand keypoint positions (inference result) for the evaluation data.

Accordingly, the user operates the input unit 21 as appropriate to specify (input) positions that should be the hand keypoints in the image as the evaluation data, that is, correct hand keypoint positions.

In step S235, the model improvement unit 36 sets, as learning data (manual labeling), data including the coordinates indicating the hand keypoint positions manually input by the user and the evaluation data to be processed, and supplies the learning data to the learning data storage area of the storage unit 23 for storage therein.

When the processing of step S235 has been performed to add the learning data, then the learning data addition processing ends. When the learning data addition processing ends, then the processing proceeds to step S15 in FIG. 3.

As described above, the model improvement unit 36 accumulates data including appropriate evaluation data and the like, as learning data for the hand keypoint detection model. In this way, it is possible to obtain, through learning, a new hand keypoint detection model that combines the advantages of each of the plurality of hand keypoint detection models already in the model group.

### <Description of Screening Processing>

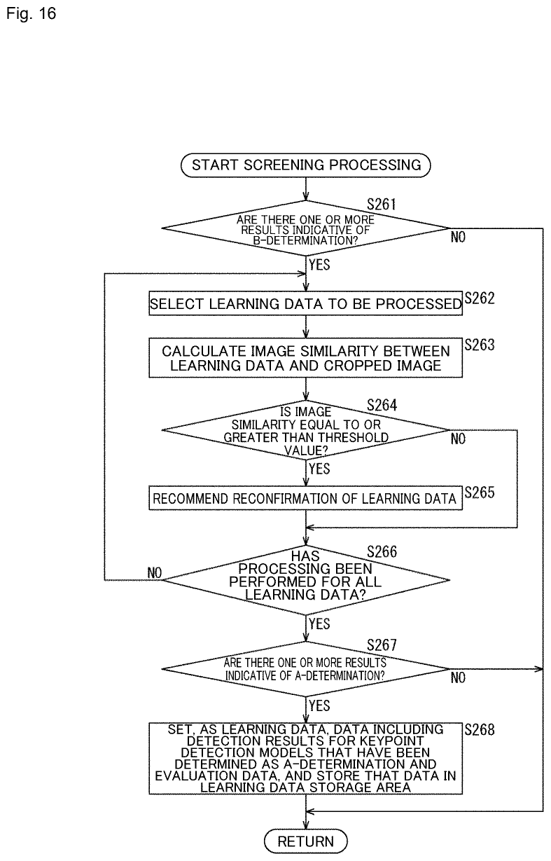

Screening processing corresponding to the processing of step S15 in FIG. 3 will be described with reference to a flowchart in FIG. 16.

In step S261, the model improvement unit 36 determines whether or not, among the evaluation results (determination results) of the combinations of the evaluation data to be processed and the hand keypoint detection models, obtained by the processing of step S13 in FIG. 3, there are one or more results indicative of B-determination.

As described above, if any of the combinations is determined as B-determination, the learning data accumulated in the learning data storage area may include inappropriate data, such as data with wrong hand keypoint positions, that is, data with incorrect labels.

If it is determined in step S261 that there is no result indicative of B-determination, the processing of steps S262 to S268 is not performed, and then the screening processing ends.

On the other hand, if it is determined in step S261 that there are one or more results indicative of B-determination, then in step S262, the model improvement unit 36 selects one piece of learning data to be processed from among the plurality of pieces of learning data stored in the learning data storage area of the storage unit 23.

In step S263, the model improvement unit 36 calculates, based on the learning data to be processed, more specifically, the image as the learning data, and based on the evaluation data of the combination that has been determined as B-determination, that is, the cropped image generated from the evaluation data to be processed, an image similarity between the learning data and the cropped image.

The cropped image for which the image similarity is to be calculated is, for example, among the S cropped images generated in step S83 in FIG. 8, the cropped image that has the largest deviation in the detection positions of hand keypoints, that is, the largest absolute value of the difference between the position p_{sjd} and the median value medianₛ(p_{sjd}) in Equation (1). Alternatively, the image similarity may be calculated for all the S cropped images.

In step S264, the model improvement unit 36 determines whether or not the image similarity is equal to or greater than a predetermined threshold value. In other words, the model improvement unit 36 identifies image data as learning data that is similar to the cropped image generated from the evaluation data to be processed.

For example, when the image similarity is large, that is, when the image similarity is equal to or greater than the threshold value, the learning data is data of a scene similar to the cropped image obtained from the evaluation data of the combination that has been determined as B-determination, and it is recommended that the learning data be reconfirmed.

If it is determined in step S264 that the image similarity is equal to or greater than the predetermined threshold value, then in step S265, the model improvement unit 36 prompts (recommends) the user to reconfirm the learning data.

For example, the model improvement unit 36 supplies image data (evaluation data) that is the learning data to be processed and the detection result of the hand keypoint positions to the display unit 22 for display, and prompts the user to reconfirm the learning data.

Accordingly, the user confirms the display on the display unit 22 to see if there are any errors in the learning data, such as some wrong hand keypoint positions, and gives instructions according to the result of the confirmation.

The instructions as referred to herein include, for example, instructions to delete the learning data, to correct the learning data by inputting hand keypoint positions (manual labeling) again, and the like, as well as instructions to use the learning data as is.

When the user operates the input unit 21 to input an instruction, the model improvement unit 36 performs processing according to the user's instruction, based on a signal supplied from the input unit 21 in response to the input. For example, the model improvement unit 36 deletes the learning data from the learning data storage area according to the instruction, or modifies the learning data based on the specified hand keypoint positions.

If it is determined in step S264 that the image similarity is not equal to or greater than the predetermined threshold value, that is, that the image similarity is smaller than the threshold value, the processing of step S265 is not performed, and then the processing proceeds to step S266.

When the processing of step S265 has been performed, or if it is determined in step S264 that the image similarity is smaller than the threshold value, the processing of step S266 is then performed.

In step S266, the model improvement unit 36 determines whether or not all the pieces of learning data stored in the learning data storage area have been processed.

If it is determined in step S266 that the processing has not yet been performed for all the pieces of learning data, then the processing returns to step S262 to repeat the above-described processing. Thus, the next piece of learning data is selected as the processing target to perform the above-described processing.

On the other hand, if it is determined in step S266 that all the pieces of learning data have been processed, then the processing proceeds to step S267.

In step S267, the model improvement unit 36 determines whether or not, among the evaluation results (determination results) of the combinations of the evaluation data to be processed and the hand keypoint detection models, obtained by the processing of step S13 in FIG. 3, there are one or more results indicative of A-determination.

If it is determined in step S267 that there is no result indicative of A-determination, the processing of step S268 is not performed, and then the screening processing ends.

On the other hand, if it is determined in step S267 that there are one or more results indicative of A-determination, the processing of step S268 is then performed.

In other words, if, among a plurality of (all) combinations of the same evaluation data and hand keypoint detection models, there are one or more hand keypoint detection models that have been determined as B-determination and there are one or more hand keypoint detection models that have been determined as A-determination, the processing of step S268 is then performed.

In step S268, the model improvement unit 36 sets, as learning data, data including the detection results (inference results) of the hand keypoint positions for the hand keypoint detection models of the combinations that have been determined as A-determination and the evaluation data to be processed, and stores the data in the learning data storage area of the storage unit 23.

Also in this case, more specifically, similarly to step S233 in FIG. 15, the detection result of the hand keypoint positions in the cropped image is converted into coordinates on the image as the evaluation data to be processed. Then, data including the coordinates (position information) indicating the converted positions and the evaluation data is stored as learning data (pseudo label) in the learning data storage area of the storage unit 23.

Since the detection results of the hand keypoint positions of combinations that have been determined as A-determination are reliable, the data obtained from such detection results can be used as appropriate learning data for learning of hand keypoint detection models.

When the processing of step S268 has been performed, the screening processing ends. When the screening processing ends, then the processing proceeds to step S16 in FIG. 3.

As described above, the model improvement unit 36 recommends the user to reconfirm, among the accumulated pieces of learning data, learning data that is similar to the cropped image obtained from the evaluation data of the combination that has been determined as B-determination.

In this way, it is possible to exclude pieces of learning data of scenes that are similar to the cropped images of the evaluation data of combinations that have been determined as B-determination, that is, scenes that are consistently mistaken, and improve the detection accuracy of the hand keypoint detection model.

### <Description of Model Presentation Processing>

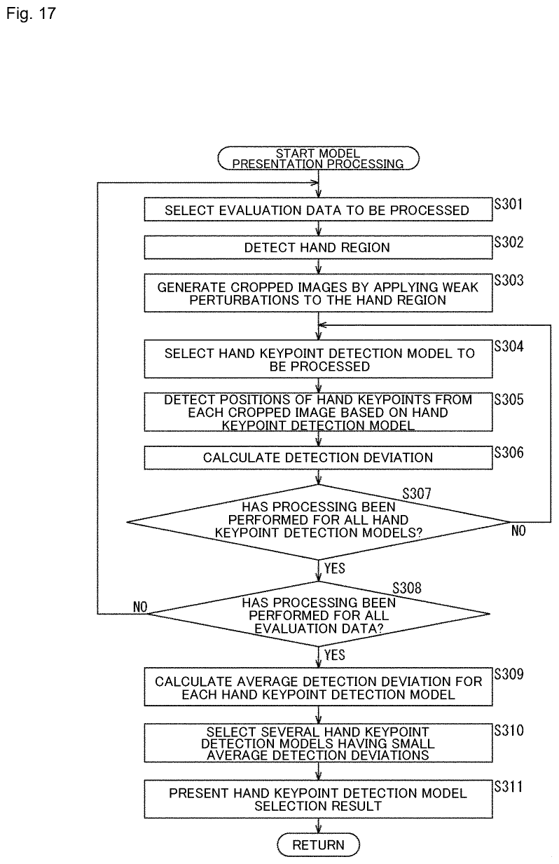

Model presentation processing corresponding to the processing of step S20 in FIG. 3 will be described with reference to a flowchart in FIG. 17.

In step S301, the processing unit 24 selects one piece of evaluation data to be processed from the pieces of evaluation data supplied from the input unit 21.

When the evaluation data to be processed is selected, the processing of steps S302 to S304 is then performed. However, the processing is the same as the processing of steps S82 to S84 in FIG. 8, and thus description thereof will be omitted.

In steps S302 and S303, a hand region is detected from the evaluation data, and based on the detection result, S cropped images in which weak perturbations have been applied are generated.

In step S304, a hand keypoint detection model to be processed is selected. In particular, in this case, the storage unit 23 stores not only the hand keypoint detection models that have already been stored before the start of the model selection processing in FIG. 3, but also the new hand keypoint detection model(s) that have been generated and added in step S18 in FIG. 3.

Therefore, in step S304, a hand keypoint detection model to be processed is selected from a plurality of hand keypoint detection models, including not only the one or more hand keypoint detection models stored in advance but also the new one or more hand keypoint detection models generated in step S18 of FIG. 3.

In step S305, the inference unit 32 detects the positions of the hand keypoints from each of the S cropped images, based on the hand keypoint detection model to be processed. In step S305, the same processing as in step S86 in FIG. 8 is performed.

In step S306, the detection deviation calculation unit 33 calculates (computes), based on the detection results of the hand keypoint positions obtained for the S cropped images, a detection deviation δ for a combination of the evaluation data to be processed and a hand keypoint detection model, using Equation (1).

In the following, the index of the evaluation data is denoted by n, the index of the hand keypoint detection model is denoted by m, and the detection deviation δ obtained for the combination of the evaluation data n and the hand keypoint detection model m is also referred to as a detection deviation δₘₙ.

In step S307, the detection deviation calculation unit 33 determines whether or not the processing of calculating the detection deviation δₘₙ has been performed for all the hand keypoint detection models.

If it is determined in step S307 that the processing has not yet been performed for all the hand keypoint detection models, then the processing returns to step S304 to repeat the above-described processing.

On the other hand, if it is determined in step S307 that the processing has been performed for all the hand keypoint detection models, then in step S308, the detection deviation calculation unit 33 determines whether or not the processing has been performed for all the pieces of evaluation data.

If it is determined in step S308 that the processing has not yet been performed for all the pieces of evaluation data, the processing returns to step S301 to repeat the above-described processing. Thus, a new piece of evaluation data is selected as the processing target, and the detection deviation δₘₙ is calculated for each combination of the evaluation data and a hand keypoint detection model.

On the other hand, if it is determined in step S308 that all the pieces of evaluation data have been processed, the processing of step S309 is then performed. In this case, the detection deviations δₘₙ are obtained for the combinations of all the pieces of evaluation data and the hand keypoint detection models.

In step S309, the model selection unit 37 calculates an average detection deviation for each hand keypoint detection model m, based on the detection deviation δₘₙ for each combination of the evaluation data and the hand keypoint detection model.

Specifically, for example, the model selection unit 37 calculates an average detection deviation δₘ by calculating the following Equation (3).

$$\begin{matrix}[ Math . 3 ] & \\ {δ}_{m} = 1 / N {\sum }_{n} {δ}_{mn} & ( 3 )\end{matrix}$$

In Equation (3), the average value of the detection deviations δₘ of all the pieces (N pieces) of evaluation data n obtained for the same hand keypoint detection model m is calculated as the average detection deviation δₘ.

This average detection deviation δₘ can be said to be an index indicating the stability (degree of stability) of detection based on the hand keypoint detection model in the environment in which the evaluation data was captured.

The index for selecting a hand keypoint detection model suitable for the environment in which the evaluation data was captured is not limited to the average detection deviation δₘ, but may be any other index as long as it is based on the detection deviation δₘₙ.

In step S310, the model selection unit 37 selects several hand keypoint detection models having small average detection deviations δₘ from among the hand keypoint detection models stored in the storage unit 23. In other words, the model selection unit 37 selects several hand keypoint detection models based on the average detection deviations δₘ.

For example, in step S310, one or more hand keypoint detection models are selected in ascending order of average detection deviations δₘ. At this time, a predetermined number of hand keypoint detection models may be selected, or all the hand keypoint detection models for which the average detection deviation δₘ is equal to or smaller than a predetermined threshold value may be selected.

The hand keypoint detection model selected in step S310 is a model that can perform the most stable detection in the environment in which the evaluation data was captured.

In step S311, the processing unit 24 controls the display unit 22 to display the hand keypoint detection model selection result in step S310 on the display unit 22, thereby presenting the hand keypoint detection model selection result to the user. At this time, the average detection deviation δₘ may also be presented (displayed) together with the hand keypoint detection model selection result.

When one or more hand keypoint detection model selection results are presented to the user, the user refers to the average detection deviation δₘ and so on, and selects (decides), from among the presented hand keypoint detection models, the most appropriate one to be installed in the inference device 71.

In this case, the user can select, from among the presented hand keypoint detection models, the one that can perform stable and accurate detection, as the model to be ultimately installed in the inference device 71, making it easier to select an appropriate hand keypoint detection model.

When the processing of step S311 has been performed to present the hand keypoint detection model selection result to the user, the model presentation processing ends, and accordingly, the model selection processing in FIG. 3 ends.

As described above, the processing unit 24 calculates the average detection deviation δₘ as an index based on the detection deviation δ, and selects an appropriate hand keypoint detection model based on the obtained average detection deviation δₘ. In this way, the user can more easily select an appropriate hand keypoint detection model.

The present technology described above is useful in the following use cases, for example.

For example, there is a machine learning model M1 that is learned using small-scale real-world data, and a machine learning model M2 that is learned using large-scale computer graphics (CG) data.

Of these two machine learning models M1 and M2, it is desired to determine which machine learning model to install in a product (corresponding to the inference device 71) that is expected to be used in various environments such as indoors and outdoors.

There is data (evaluation data) captured with an RGB camera of a scene in which the product is expected to be used, but the data does not have annotation.

Using the present technology in such a scenario (use case) would enable the selection of a more stable machine learning model based on the detection deviation.

In addition, presenting weak data and screening learning data makes it possible to learn a new machine learning model M3 that combines the good points (advantages) of machine learning models M1 and M2.

For example, if a product is installed with a hand recognition model as a machine learning model, the user of the product will be able to experience various applications that use hand recognition by utilizing the optimal hand recognition model installed in the product.

### <Configuration Example of Computer>

The above-described series of processing can be performed by hardware or software. In the case where the series of processing is performed by software, a program that configures the software is installed on a computer. Here, the computer includes, for example, a computer built in dedicated hardware, a general-purpose personal computer on which various programs are installed to be able to implement various functions, and the like.

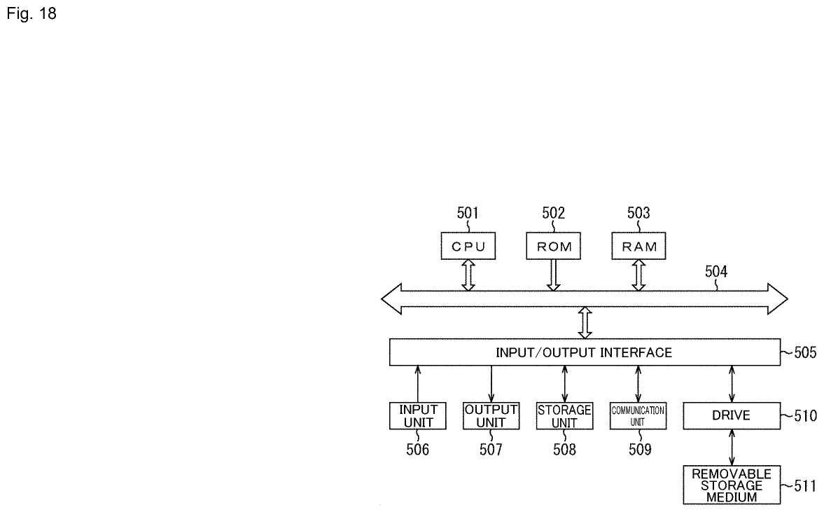

FIG. 18 is a block diagram illustrating a configuration example of computer hardware that performs the above-described series of processing using a program.

In the computer, a central processing unit (CPU) 501, a read only memory (ROM) 502, and a random access memory (RAM) 503 are connected to one another by a bus 504.

The bus 504 is further connected with an input/output interface 505. An input unit 506, an output unit 507, a storage unit 508, a communication unit 509, and a drive 510 are connected to the input/output interface 505.

The input unit 506 includes a keyboard, a mouse, a microphone, and an imaging element. The output unit 507 includes a display and a speaker. The storage unit 508 is a hard disk, non-volatile memory, or the like. The communication unit 509 includes a network interface or the like. The drive 510 drives a removable storage medium 511, for example, a magnetic disk, an optical disc, a magneto-optical disk, or a semiconductor memory.

In the computer configured as described above, for example, the CPU 501 loads a program recorded in the storage unit 508 into the RAM 503 via the input/output interface 505 and the bus 504 and executes the program to perform the above-described series of processing.

The program executed by the computer (the CPU 501) can be stored on, for example, the removable storage medium 511, as a packaged medium, and provided in such a state. The program can be also provided through a wired or wireless transmission medium such as a local area network, the Internet, or digital satellite broadcasting.

In the computer, the program can be installed in the storage unit 508 via the input/output interface 505 by inserting the removable storage medium 511 into the drive 510. The program can be received by the communication unit 509 via a wired or wireless transfer medium to be installed in the storage unit 508. In addition, the program may be installed in advance in the ROM 502 or the storage unit 508.

The program executed by a computer may be a program that performs processing in time series in order described in the present specification or may be a program that performs processing in parallel or at a necessary timing such as when a called is made.

Embodiments of the present technology are not limited to the above-described embodiments and can be changed in various ways without departing from the spirit and scope of the present technology.

For example, the present technology may be configured as cloud computing in which a single function is cooperatively processed in a distributed manner via a network.

In addition, each step described in the flowchart discussed above can be executed by a single device, or executed by a plurality of devices in a distributed manner.

Furthermore, when a single step includes a plurality of types of processing, the plurality of types of processing included in the single step can be performed by a single device, or in a distributed manner by a plurality of devices.

Furthermore, the present technology can be also configured as follows.

(1)

An information processing device including:
an inference unit that generates a plurality of pieces of second data by applying weak perturbations to first data without annotation obtained in an unknown environment, and performs, using the pieces of second data as inputs to a model, inference on the pieces of second data based on the model;
a deviation calculation unit that calculates, based on a result of the inference on the plurality of pieces of second data, a deviation of the result of the inference; and a model selection unit that selects, based on the deviation for each of a plurality of the models, one or more of the models from among the plurality of models.
   (2)

The information processing device according to (1), wherein the model selection unit calculates a predetermined index based on the deviation for each of the models obtained for each of a plurality of pieces of the first data, and selects the model based on the index.

(3)

The information processing device according to (1) or (2), wherein the first data is image data.

(4)

The information processing device according to (3), wherein the inference is detection of a keypoint position.

(5)

The information processing device according to any one of (1) to (4), wherein the weak perturbation is a shift, scaling, or rotation.

(6)

The information processing device according to (3) or (4), further including: an interpretation unit that evaluates reliability and stability of the inference for a combination of the first data and the model based on the deviation and the result of the inference; and
a model improvement unit that learns a new model using, as learning data, data including the first data and the result of the inference, stored according to a result of the evaluation,
wherein
the model selection unit selects one or more of the models from among the plurality of the models including the plurality of the models prepared in advance and the new model.
   (7)

The information processing device according to (6), wherein the interpretation unit determines the result of the evaluation of the combination as one of:
a first evaluation result that is a stable and correct inference,
a second evaluation result that is a stable but incorrect inference, and
a third evaluation result that is an unstable and incorrect inference.
   (8)

The information processing device according to (7), wherein when, among a plurality of the combinations for the same first data, there are one or more combinations that have been determined as the third evaluation result and there are one or more combinations that have been determined as the first evaluation result, the model improvement unit sets, as learning data for the new model, data including the first data and results of the inference of the combinations that have been determined as the first evaluation result.

(9)

The information processing device according to (7) or (8), wherein when, among all the combinations for the same first data, there is no combination that has been determined as the first evaluation result, the model improvement unit prompts a user to input a correct result of the inference for the first data, and sets, as learning data for the new model, data including the first data and the result of the inference input by the user.

(10)

The information processing device according to any one of (7) to (9), wherein when, among a plurality of the combinations for the same first data, there are one or more combinations that have been determined as the second evaluation result, the model improvement unit identifies, from among already stored pieces of learning data for the new model, learning data that is similar to the second data obtained from the first data of the combination that has been determined as the second evaluation result, and prompts a user to reconfirm the identified learning data.

(11)

The information processing device according to any one of (7) to claim (10), wherein when, among a plurality of the combinations for the same first data, there are one or more combinations that have been determined as the second evaluation result and there are one or more combinations that have been determined as the first evaluation result, the model improvement unit sets, as learning data for the new model, data including the first data and results of the inference of the combinations that have been determined as the first evaluation result.

(12)

The information processing device according to any one of (7) to (11), wherein the interpretation unit determines the result of the evaluation of the combination as the first evaluation result or the second evaluation result based on an input operation by a user.

(13)

The information processing device according to (12), wherein the interpretation unit displays an image based on the second data for the combination, superimposes and displays the result of the inference on the image, and allows the user to select the first evaluation result or the second evaluation result as a result of the evaluation of the combination.

(14)

The information processing device according to (13) wherein the interpretation unit displays the image and the result of the inference side by side for two or more of the combinations.

(15)

The information processing device according to (14), wherein when the deviation of a predetermined combination and the deviation of another combination are both smaller than a first threshold value and a difference between the result of the inference for the predetermined combination and the result of the inference for the other combination is larger than a second threshold value, the interpretation unit displays the image and the result of the inference side by side for the predetermined combination and the other combination.

(16)

The information processing device according to any one of (13) to (15), wherein the interpretation unit displays an image based on the first data, and superimposes and displays the result of the inference on the image based on the first data.

(17)

The information processing device according to (16), wherein the interpretation unit further displays a detection result of a region of a subject to be inferred on the image based on the first data.

(18)

The information processing device according to any one of (7) to (17), further including a correct/incorrect determination model learning unit that learns a correct/incorrect determination model that uses, as learning data, data including the second data, the result of the inference and a result of a correct/incorrect determination of the result of the inference input by a user, uses, as inputs, the second data and the result of the inference, and outputs a result of a correct/incorrect determination of the result of the inference.

(19)

The information processing device according to (18), wherein the interpretation unit evaluates the combination based on the second data, the result of the inference, the correct/incorrect determination model, and the deviation.

(20)

The information processing device according to (19), wherein the interpretation unit displays, for the combination, an image based on the second data, superimposes and displays the result of the inference on the image based on the second data, and displays a result of a correct/incorrect determination of the result of the inference based on the correct/incorrect determination model.

(21)

The information processing device according to any one of (7) to (20), wherein when the deviation is equal to or greater than a first threshold value, the interpretation unit determines the result of the evaluation of the combination as the third evaluation result.

(22)

An information processing method performed by an information processing device, the method including:
generating a plurality of pieces of second data by applying weak perturbations to first data without annotation obtained in an unknown environment;
performing, using the pieces of second data as inputs to a model, inference on the pieces of second data based on the model;
calculating, based on a result of the inference on the plurality of pieces of second data, a deviation of the result of the inference; and
selecting, based on the deviation for each of a plurality of the models, one or more of the models from among the plurality of models.
   (23)

A program causing a computer to execute processing including the steps of: generating a plurality of pieces of second data by applying weak perturbations to first data without annotation obtained in an unknown environment;
performing, using the pieces of second data as inputs to a model, inference on the pieces of second data based on the model;
calculating, based on a result of the inference on the plurality of pieces of second data, a deviation of the result of the inference; and
selecting, based on the deviation for each of a plurality of the models, one or more of the models from among the plurality of models.

### REFERENCE SIGNS LIST

11 Model sorting device
21 Input unit
22 Display unit
23 Storage unit
24 Processing unit
31 Hand region calculation unit
32 Inference unit
33 Detection deviation calculation unit
34 Detection result interpretation unit
35 Correct/incorrect determination model learning unit
36 Model improvement unit
37 Model selection unit

1. An information processing device comprising:
an inference unit that generates a plurality of pieces of second data by applying weak perturbations to first data without annotation obtained in an unknown environment, and performs, using the pieces of second data as inputs to a model, inference on the pieces of second data based on the model;
a deviation calculation unit that calculates, based on a result of the inference on the plurality of pieces of second data, a deviation of the result of the inference; and
a model selection unit that selects, based on the deviation for each of a plurality of the models, one or more of the models from among the plurality of models.

2. The information processing device according to claim 1, wherein the model selection unit calculates a predetermined index based on the deviation for each of the models obtained for each of a plurality of pieces of the first data, and selects the model based on the index.

3. The information processing device according to claim 1, wherein the first data is image data.

4. The information processing device according to claim 3, wherein the inference is detection of a keypoint position.

5. The information processing device according to claim 1, wherein the weak perturbation is a shift, scaling, or rotation.

6. The information processing device according to claim 3, further comprising:
an interpretation unit that evaluates reliability and stability of the inference for a combination of the first data and the model based on the deviation and the result of the inference; and
a model improvement unit that learns a new model using, as learning data, data including the first data and the result of the inference, stored according to a result of the evaluation,
wherein
the model selection unit selects one or more of the models from among the plurality of the models including the plurality of the models prepared in advance and the new model.

7. The information processing device according to claim 6, wherein
the interpretation unit determines the result of the evaluation of the combination as one of:
a first evaluation result that is the stable and correct inference,
a second evaluation result that is the stable but incorrect inference, and
a third evaluation result that is the unstable and incorrect inference.

8. The information processing device according to claim 7, wherein when, among a plurality of the combinations for the same first data, there are one or more combinations that have been determined as the third evaluation result and there are one or more combinations that have been determined as the first evaluation result, the model improvement unit sets, as learning data for the new model, data including the first data and results of the inference of the combinations that have been determined as the first evaluation result.

9. The information processing device according to claim 7, wherein when, among all the combinations for the same first data, there is no combination that has been determined as the first evaluation result, the model improvement unit prompts a user to input a correct result of the inference for the first data, and sets, as learning data for the new model, data including the first data and the result of the inference input by the user.

10. The information processing device according to claim 7, wherein when, among a plurality of the combinations for the same first data, there are one or more combinations that have been determined as the second evaluation result, the model improvement unit identifies, from among already stored pieces of learning data for the new model, learning data that is similar to the second data obtained from the first data of the combination that has been determined as the second evaluation result, and prompts a user to reconfirm the identified learning data.

11. The information processing device according to claim 7, wherein when, among a plurality of the combinations for the same first data, there are one or more combinations that have been determined as the second evaluation result and there are one or more combinations that have been determined as the first evaluation result, the model improvement unit sets, as learning data for the new model, data including the first data and results of the inference of the combinations that have been determined as the first evaluation result.

12. The information processing device according to claim 7, wherein the interpretation unit determines the result of the evaluation of the combination as the first evaluation result or the second evaluation result based on an input operation by a user.

13. The information processing device according to claim 12, wherein the interpretation unit displays an image based on the second data for the combination, superimposes and displays the result of the inference on the image, and allows the user to select the first evaluation result or the second evaluation result as a result of the evaluation of the combination.

14. The information processing device according to claim 13, wherein the interpretation unit displays an image based on the first data, and superimposes and displays the result of the inference on the image based on the first data.

15. The information processing device according to claim 14, wherein the interpretation unit further displays a detection result of a region of a subject to be inferred on the image based on the first data.

16. The information processing device according to claim 7, further comprising a correct/incorrect determination model learning unit that learns a correct/incorrect determination model that uses, as learning data, data including the second data, the result of the inference and a result of a correct/incorrect determination of the result of the inference input by a user, uses, as inputs, the second data and the result of the inference, and outputs a result of a correct/incorrect determination of the result of the inference.

17. The information processing device according to claim 16, wherein the interpretation unit evaluates the combination based on the second data, the result of the inference, the correct/incorrect determination model, and the deviation.

18. The information processing device according to claim 17, wherein the interpretation unit displays, for the combination, an image based on the second data, superimposes and displays the result of the inference on the image based on the second data, and displays a result of a correct/incorrect determination of the result of the inference based on the correct/incorrect determination model.

19. An information processing method performed by an information processing device, the method comprising:
generating a plurality of pieces of second data by applying weak perturbations to first data without annotation obtained in an unknown environment;
performing, using the pieces of second data as inputs to a model, inference on the pieces of second data based on the model;
calculating, based on a result of the inference on the plurality of pieces of second data, a deviation of the result of the inference; and
selecting, based on the deviation for each of a plurality of the models, one or more of the models from among the plurality of models.

20. A program causing a computer to execute processing including the steps of:
generating a plurality of pieces of second data by applying weak perturbations to first data without annotation obtained in an unknown environment;
performing, using the pieces of second data as inputs to a model, inference on the pieces of second data based on the model;
calculating, based on a result of the inference on the plurality of pieces of second data, a deviation of the result of the inference; and
selecting, based on the deviation for each of a plurality of the models, one or more of the models from among the plurality of models.
